(19) United States
(12) Patent Application Publication
(10) Pub. No.: US 2010/0020396 A1
(43) Pub. Date: Jan. 28, 2010

(54) POLARIZER PROTECTIVE FILM, POLARIZING PLATE, AND IMAGE DISPLAY APPARATUS

(75) Inventors: Hiroko Izumi, Tsukuba-shi (JP); Yoshitomo Nakata, Nishinomiya-shi (JP); Ken-Ichi Ueda, Nara-shi (JP); Daisuke Hattori, Ibaraki-shi (JP); Tadashi Kojima, Ibaraki-shi (JP); Hiroyuki Takao, Osaka (JP); Tsutomu Hani, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NIPPON SHOKUBAI CO., LTD., Osaka-shi, Osaka (JP); NITTO DENKO CORPORATION, Ibaraki-shi, Osaka (JP)

(21) Appl. No.: 12/445,666

(22) PCT Filed: Sep. 27, 2007
(86) PCT No.: PCT/JP2007/068774

§ 371 Date: Apr. 15, 2009

(30) Foreign Application Priority Data
Oct. 26, 2006 (JP) 2006-291049
Mar. 30, 2007 (JP) 2007-091179

(51) Int. Cl. G02B 27/28; F21V 9/06

(52) U.S. Cl. 359/485; 252/589

(57) ABSTRACT

Provided are: a polarizer protective film, which is allowed to express excellent UV-absorbing ability by using a UV-absorbing monomer as a raw material, has excellent heat resistance and excellent optical transparency, and has much less coloring and foaming; a polarizing plate with less defects in an outer appearance, using the polarizer protective film; and an image display apparatus of high quality, using the polarizing plate. The polarizer protective film of the present invention has a light transmittance at 380 nm in a thickness of 80 μm of 30% or less, and is obtained by molding a forming material that contains a resin component containing as a main component a (meth)acrylic resin obtained by polymerizing a monomer composition containing a UV-absorbing monomer and a (meth)acrylic monomer by extrusion molding.

### TECHNICAL FIELD

The present invention relates to a polarizer protective film, a polarizing plate using the polarizer protective film, and an image display apparatus such as a liquid crystal display apparatus, an organic EL display apparatus, or a PDP including at least the one polarizing plate.

### BACKGROUND ART

A liquid crystal display apparatus must have polarizing plates arranged on both sides of a glass substrate forming the surface of a liquid crystal panel due to its image forming system. Such a polarizing plate to be used is generally manufactured by attaching a polarizer protective film on both sides of a polarizer made of a polyvinyl alcohol-based film and a dichromatic substance such as iodine by using a polyvinyl alcohol-based adhesive.

The polarizer protective film may be required to have UV-absorbing ability for the purpose of preventing liquid crystal and the polarizer from being degraded by UV-light. As a resin component for an optical film used as a polarizer protective film, triacetyl cellulose has been generally used heretofore. Currently, a UV absorber is added to a triacetyl cellulose film as the polarizer protective film, whereby the polarizer protective film is provided with UV-light absorbing ability.

However, triacetyl cellulose has insufficient heat and humidity resistance and thus has a problem in that properties such as a polarization degree and a hue of a polarizing plate degrade when a polarizing plate using the triacetyl cellulose film as a polarizer protective film is used under high temperature or high humidity conditions. Further, the triacetyl cellulose film causes retardation with respect to incident light in an oblique direction. With the increase in size of a liquid crystal display in recent years, the retardation has had significant effects on viewing angle properties.

As a material for the polarizer protective film that replaces conventionally used triacetyl cellulose, a transparent thermoplastic resin has been considered, and a polarizer protective film that is provided with UV-absorbing ability by adding a UV absorber to a transparent thermoplastic resin has been also reported (see Patent Documents 1 and 2). However, such a polarizer protective film has: a problem that glass transition temperature (Tg) of the material resin with the UV absorber added thereto remarkably lowers compared to Tg of the material resin before the UV absorber is added thereto (problem of decrease in heat resistance); and a problem of coloring (yellowing) of the resin. Thus, there is a strong demand for the development of a polarizer protective film having excellent heat resistance and excellent optical transparency, as well as excellent UV-absorbing ability.
Patent Document 1: JP 09-166711 A
Patent Document 2: JP 2004-45893 A

### DISCLOSURE OF THE INVENTION

### Problems To Be Solved By the Invention

The objects of the present invention are: (1) to provide a polarizer protective film that is allowed to express excellent UV-absorbing ability by using a UV-absorbing monomer as a raw material, has excellent heat resistance and excellent optical transparency, and has much less coloring and foaming; (2) to provide a polarizing plate with less defects in an outer appearance, using the polarizer protective film; and (3) to provide an image display apparatus of high quality, using the polarizing plate.

### Means For Solving the Problems

A polarizer protective film of the present invention has a light transmittance of 30% or less at 380 nm in a thickness of 80 μm, and is obtained by molding a forming material containing a resin component, which contains as a main component a (meth)acrylic resin obtained by polymerizing a monomer composition containing a UV-absorbing monomer and a (meth)acrylic monomer, by extrusion molding.

In a preferred embodiment, the UV-absorbing monomer includes a benzophenone-based UV-absorbing-monomer and/or a benzotriazole-based UV-absorbing monomer.

In a preferred embodiment, a content of the UV-absorbing monomer in the monomer composition is 1 to 30% by weight.

In a preferred embodiment, the (meth)acrylic resin has a (meth)acrylic resin having a lactone ring structure.

In a preferred embodiment, a b-value in the thickness of 80 μm is less than 1.5.

In a preferred embodiment, the forming material contains, with respect to 100 parts by weight of the resin component, 0.2 part by weight or more of an antioxidant having a weight reduction of 10% or less in heating at 280° C. for 20 minutes.

In a preferred embodiment, the antioxidant contains a phenol-based antioxidant.

In a preferred embodiment, the antioxidant contains, with respect to 100 parts by weight of the resin component, 0.1 part by weight or more of the phenol-based antioxidant and 0.1 part by weight or more of a thioether-based antioxidant.

In a preferred embodiment, the antioxidant contains, with respect to 100 parts by weight of the resin component, 0.1 part by weight or more of the phenol-based antioxidant and 0.1 part by weight or more of a phosphorus-based antioxidant.

In a preferred embodiment, a temperature of the forming material during the extrusion molding is 250° C. or higher.

According to another aspect of the present invention, a polarizing plate is provided. The polarizing plate of the present invention includes a polarizer formed of a polyvinyl alcohol-based resin and an optical film of the present invention which is the polarizer protective film, in which the polarizer is bonded to the polarizer protective film via an adhesive layer.

In a preferred embodiment, the adhesive layer is formed of a polyvinyl alcohol-based adhesive.

In a preferred embodiment, the polarizing plate further includes a pressure-sensitive adhesive layer as at least one of an outermost layer.

According to another aspect of the present invention, an image display apparatus is provided. The image display apparatus of the present invention includes at least one polarizing plate of the present invention.

### EFFECTS OF THE INVENTION

According to the present invention, the polarizer protective film can be provided, which is allowed to express excellent UV-absorbing ability by using the UV-absorbing monomer as a raw material, has excellent heat resistance and excellent optical transparency, and has much less coloring and foaming. Further, the polarizing plate with less defects in an outer appearance, using the polarizer protective film, can be provided. Further, the image display apparatus of high quality, using the polarizing plate, can be provided.

Those effects can be expressed by using, as a forming material for extrusion molding, a forming material that contains a resin component containing as a main component a (meth)acrylic resin obtained by polymerizing a monomer composition containing a UV-absorbing monomer and a (meth)acrylic monomer.

### BRIEF DESCRIPTION OF THE DRAWINGS

FIG. 1 is a cross-sectional view illustrating an example of a polarizing plate of the present invention.

FIG. 2 is a schematic cross-sectional view of a liquid crystal display apparatus according to a preferred embodiment of the present invention.

### DESCRIPTION OF NUMERALS

10 liquid crystal cell
11, 11′ glass substrate
12 liquid crystal layer
13 spacer
20, 20′ retardation film
30, 30′ polarizing plate
31 polarizer
32 adhesive layer
33 easy adhesion layer
34 polarizer protective film
35 adhesive layer
36 optical film
40 light guide plate
50 light source
60 reflector
100 liquid crystal display apparatus

### BEST MODE FOR CARRYING OUT THE INVENTION

Hereinafter, description of preferred embodiments of the present invention is given, but the present invention is not limited to the embodiments.

### [A. Polarizer Protective Film]

### [A-1. Resin Component]

The polarizer protective film of the present invention is obtained by molding a forming material containing a resin component that contains a (meth)acrylic resin as a main component by extrusion molding. That is, the polarizer protective film of the present invention contains a (meth)acrylic resin as a main component.

The (meth)acrylic resin is obtained by polymerizing a monomer composition containing a UV-absorbing monomer and a (meth)acrylic monomer. The UV-absorbing monomer may be used alone or in combination. The (meth)acrylic resin may be used alone or in combination.

The content of the UV-absorbing monomer in the monomer composition is preferably 1 to 30% by weight, more preferably 2 to 25% by weight, still more preferably 3 to 20% by weight, and particularly preferably 5 to 15% by weight. If the content of the UV-absorbing monomer in the monomer composition is in the above range, UV-absorbing ability can be exhibited sufficiently, and the copolymerizability with the (meth)acrylic monomer is not impaired.

As the UV-absorbing monomer, a monomer having any appropriate UV-absorbing ability can be adopted as long as the effects of the present invention are not impaired. Preferred examples thereof include a benzophenone-based UV-absorbing monomer, a benzotrizole-based UV-absorbing monomer, and a triazine-based UV-absorbing monomer.

Examples of the benzophenone-based UV-absorbing monomer include 2-hydroxy-4-acryloyloxybenzophenone, 2-hydroxy-4-methacryloyloxybenzophenone, 2-hydroxy-4-(2-acryloyloxy)ethoxybenzophenone, 2-hydroxy-4-(2-methacryloyloxy)ethoxybenzophenone, and 2-hydroxy-4-(2-methyl-2-acryloyloxy)ethoxybenzophenone.

Examples of the benzotriazole-based UV-absorbing monomer include
2-[2-hydroxy-5 -(acryloyloxymethyl)phenyl]benzotriazole,
2-[2′-hydroxy-5′-(methacryloyloxy)phenyl]benzotriazole,
2-[2′-hydroxy-5′-(acryloyloxy)phenyl]benzotriazole,
2-[2′-hydroxy-3′-t-butyl-5′-(methacryloyloxy)phenyl]benzotriazole,
2-[2′-hydroxy-3′-methyl-5′-(acryloyloxy)phenyl]benzotriazole,
2-[2′-hydroxy-5′-(methacryloyloxypropyl)phenyl]-5-chlorobenzotriazole,
2-[2′-hydroxy-5′-(methacryloyloxyethyl)phenyl]benzotriazole,
2-[2′-hydroxy-5′-(acryloyloxyethyl)phenyl]benzotriazole,
2-[2′-hydroxy-3′-t-butyl-5′-(methacryloyloxyethyl)phenyl]benzotriazole,
2-[2′-hydroxy-3′-methyl-5′-(acryloyloxyethyl)phenyl]benzotriazole,
2-[2′-hydroxy-5′-(acryloyloxybutyl)phenyl]-5-methylbenzotriazole,
[2-hydroxy-3-t-butyl-5-(acryloyloxyethoxycarbonylethyl)phenyl]benzotriazole,
2-[2′-hydroxy-5′-(methacryloyloxyethyl)phenyl]-2H-benzotriazole (RUVA-93),
2-[2′-hydroxy-5′-(methacryloyloxy)phenyl]-2H-benzotriazole,
2-[2′-hydroxy-3′-t-butyl-5′-(methacryloyloxy)phenyl]-2H-benzotriazole, and UVA-5 represented by the following chemical formula.

Examples of the triazine-based UV-absorbing monomer include UVA-2, UVA-3, and UVA-4 represented by the following Chemical Formula.

Among the UV-absorbing monomers, the benzotriazole-based UV-absorbing monomer and the triazine-based UV-absorbing monomer are preferred, RUVA-93, UVA-2, UVA-3, UVA-4, and UVA-5 are more preferred, and UVA-5 is particularly preferred, because they exhibit UV-absorbing ability in a small amount.

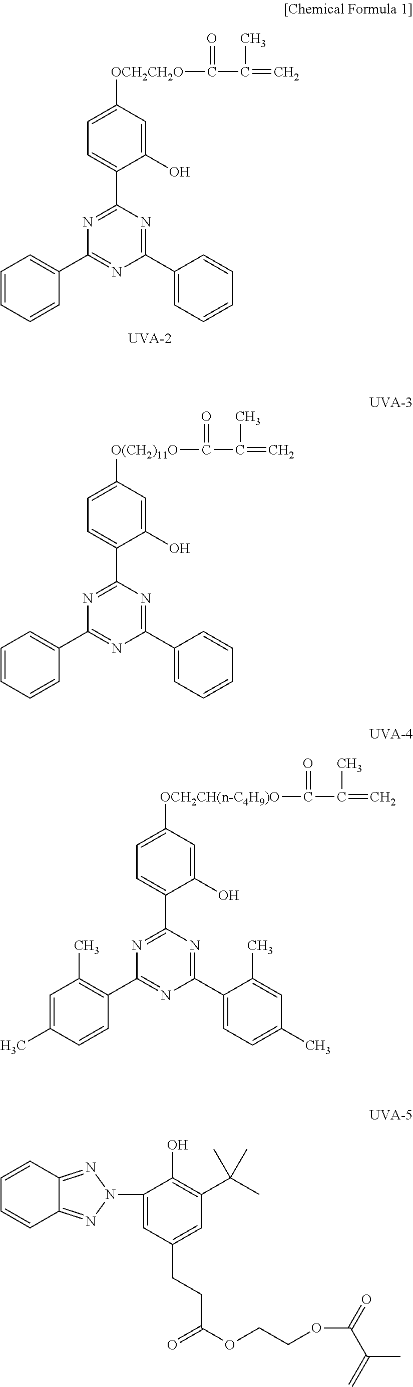

As the (meth)acrylic monomer, any appropriate (meth)acrylic monomer can be adopted as long as the effects of the present invention are not impaired. Examples thereof include (meth)acrylic acid and (meth)acrylate. Preferred examples include C₁₋₆ alkyl(meth)acrylate. A more preferred example includes methyl methacrylate.

The monomer composition may include any appropriate other monomers in addition to the UV-absorbing monomers and the (meth)acrylic monomers as long as the effects of the present invention are not impaired. Examples of the other monomers include styrene, norbornene, and N-substituted maleimide. Specific examples of N-substituted maleimide include N-cyclohexylmaleimide, N-phenylmaleimide, N-methylmaleimide, N-ethylmaleimide, N-isopropylmaleimide, N-t-butylmaleimide, and N-benzylmaleimide. Of those N-substituted maleimides, N-phenylmaleimide and N-cyclohexylmaleimide are particularly preferred because they are excellent in heat resistance, transparency, and low colorability. Those N-substituted maleimides may be used alone or in combination. In the case where the N-substituted maleimide is used, the content ratio thereof is preferably 15 to 50 wt % in the monomer composition. When the content ratio of N-substituted maleimide is less than 15 wt %, heat resistance may decrease. When the content ratio of N-substituted maleimide exceeds 50 wt %, transparency may deteriorate.

As the method of polymerizing the monomer composition, any appropriate polymerization method can be adopted as long as the effects of the present invention are not impaired.

The Tg (glass transition temperature) of the (meth)acrylic resin is preferably 110° C. or higher, more preferably 115° C. or higher, still more preferably 120° C. or higher, particularly preferably 125° C. or higher, and most preferably 130° C. or higher. In the polarizer protective film of the present invention, when the (meth)acrylic resin having a Tg (glass transition temperature) of 110° C. or higher is incorporated as a main component, the polarizer protective film has excellent durability when incorporated in a polarizing plate as a polarizer protective film. The upper limit value of the Tg of the (meth)acrylic resin is not particularly limited. However, it is preferably 170° C. or lower in view of the forming property and the like.

As the (meth)acrylic resin, in view of high heat resistance, high transparency, and high mechanical strength, a (meth)acrylic resin having a lactone ring structure is preferred.

Examples of the (meth)acrylic resin having a lactone ring structure include (meth)acrylic resins obtained from a monomer composition further including the UV-absorbing monomer in the monomer composition used in producing the (meth)acrylic resin having a lactone ring structure, which are described in JP 2000-230016 A, JP2001-151814A, JP2002-120326A, JP2002-254544A, JP2005-146084 A, and JP 2006-171464 A.

The (meth)acrylic resin having a lactone ring structure preferably has a lactone ring structure represented by the following General Formula (1).

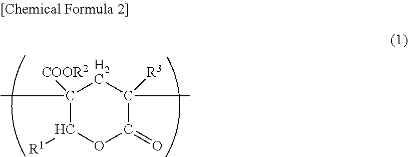

In General Formula (1), R¹, R², and R³ independently represent hydrogen atoms or organic residues containing 1 to 20 carbon atoms. The organic residues may contain oxygen atoms.

Preferred examples of the organic residue include specifically: alkyl groups having 1 to 20 carbon atoms such as a methyl group, an ethyl group, and a propyl group; unsaturated aliphatic hydrocarbon groups having 1 to 20 carbon atoms such as an ethenyl group and a propenyl group; aromatic hydrocarbon groups having 1 to 20 carbon atoms such as a phenyl group and a naphtyl group; groups in which at least one hydrogen atom of the alkyl group, the unsaturated hydrocarbon group, and the aromatic hydrocarbon group is replaced by a hydroxyl group; groups in which at least one hydrogen atom of the alkyl group, the unsaturated hydrocarbon group, and the aromatic hydrocarbon group is replaced by a carboxyl group; groups in which at least one hydrogen atom of the alkyl group, the unsaturated hydrocarbon group, and the aromatic hydrocarbon group is replaced by an ether group; and groups in which at least one hydrogen atom of the alkyl group, the unsaturated hydrocarbon group, and the aromatic hydrocarbon group is replaced by an ester group.

The content ratio of the lactone ring structure represented by General Formula (1) in the structure of the (meth)acrylic resin having a lactone ring structure is preferably 5 to 90% by weight, more preferably 10 to 70% by weight, still more preferably 10 to 60% by weight, and particularly preferably 10 to 50% by weight. When the content ratio of the lactone ring structure represented by General Formula (1) in the structure of the (meth)acrylic resin having a lactone ring structure is smaller than 5% by weight, the heat resistance, solvent resistance, and surface hardness may become insufficient. When the content ratio of the lactone ring structure represented by General Formula (1) in the structure of the (meth)acrylic resin having a lactone ring structure is larger than 90% by weight, the forming property may become poor.

The (meth)acrylic resin having a lactone ring structure may have a structure other than that represented by General Formula (1). As the structure other than the lactone ring structure represented by General Formula (1), for example, a polymer structure unit (repeating unit) constructed by polymerizing at least one kind selected from a (meth)acrylate, a hydroxyl group-containing monomer, an unsaturated carboxylic acid, and a monomer represented by the following General Formula (2), as described later in a method of producing a (meth)acrylic resin having a lactone ring structure is preferred.

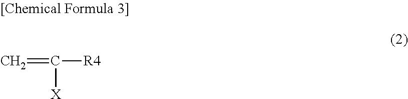

In General Formula (2): R⁴ represents a hydrogen atom or a methyl group; X represents a hydrogen atom, an alkyl group having 1 to carbon atoms, an aryl group, an —OAc group, a —CN group, a CO—R⁵ group, or a —C—O—R⁶ group; an Ac group represents an acetyl group; and R⁵ and R⁶ represent hydrogen atoms or organic residues having 1 to 20 carbon atoms.

The content ratio of the structure other than the lactone ring structure represented by General Formula (1) in the (meth)acrylic resin structure having a lactone ring structure is preferably 10 to 95% by weight, more preferably 10 to 90% by weight, still more preferably 40 to 90% by weight, and particularly preferably 50 to 90% by weight in the case of a polymer structure unit (repeating structure unit) constructed by polymerizing a (meth)acrylate, and preferably 0 to 30% by weight, more preferably 0 to 20% by weight, still more preferably 0 to 15% by weight, and particularly preferably 0 to 10% by weight in the case of a polymer structure unit (repeating structure unit) constructed by polymerizing a hydroxyl group-containing monomer. The content ratio is preferably 0 to 30% by weight, more preferably 0 to 20% by weight, still more preferably 0 to 15% by weight, and particularly preferably 0 to 10% by weight in the case of a polymer structure unit (repeating structure unit) constructed by polymerizing an unsaturated carboxylic acid. The content ratio is preferably 0 to 30% by weight, more preferably 0 to 20% by weight, still more preferably 0 to 15% by weight, and particularly preferably 0 to 10% by weight in the case of polymer structure unit (repeating structure unit) constructed by polymerizing a monomer represented by General Formula (2).

The weight average molecular weight (which may be referred to as mass average molecular weight) of the (meth)acrylic resin having a lactone ring structure is preferably 1,000 to 2,000,000, more preferably 5,000 to 1,000,000, still more preferably 10,000 to 500,000, and particularly preferably 50,000 to 500,000. When the weight average molecular weight is out of the above range, the effects of the present invention may not be exhibited sufficiently.

The Tg (glass transition temperature) of the (meth)acrylic resin having a lactone ring structure is preferably 110° C. or higher, more preferably 115° C. or higher, still more preferably 120° C. or higher, still more preferably 125° C. or higher, still more preferably 130° C. or higher, particularly preferably 135° C. or higher, and most preferably 140° C. or higher. When the Tg is 110° C. or higher, for example, in a case where the (meth)acrylic resin having such a Tg is finally incorporated in a polarizing plate as a polarizer protective film, the polarizing plate has excellent durability. The upper limit value of the Tg of the (meth)acrylic resin having a lactone ring structure is not particularly limited. However, it is preferably 170° C. or lower in view of the forming property and the like.

Regarding the (meth)acrylic resin having a lactone ring structure, the total light transmittance measured by a method pursuant to ASTM-D-1003 of a molding obtained by injection molding is preferably as high as possible, and is preferably 85% or higher, more preferably 88% or higher, and still more preferably 90% or higher. The total light transmittance is an index of transparency. When the total light transparency is less than 85%, the transparency decreases, which may make it impossible to use the resultant as a polarizer protective film.

The (meth)acrylic resin having a lactone ring structure may be produced by any appropriate method. The methods of producing (meth)acrylic resins having lactone ring structures described in JP 2000-230016 A, JP 2001-151814 A, JP 2002-120326 A, JP 2002-254544 A, JP 2005-146084 A, and JP 2006-171464 A may be employed.

The content of the (meth)acrylic resin in the polarizer protective film of the present invention is preferably 50 to 100% by weight, more preferably 50 to 99%byweight, still more preferably 60 to 98% by weight, and particularly preferably 70 to 97% by weight. In a case where the content of the (meth)acrylic resin in the polarizer protective film of the present invention is less than 50% by weight, the high heat resistance and high transparency originally owned by the (meth)acrylic resin may not be reflected sufficiently.

The polarizer protective film of the present invention may contain a resin component other than the (meth)acrylic resin. As the resin component other than the (meth)acrylic resin, any appropriate resin component can be adopted as long as the effects of the present invention are not impaired.

The content of the (meth)acrylic resin in the forming material used for molding the polarizer protective film of the present invention is preferably 50 to 100% by weight, more preferably 50 to 99% by weight, still more preferably 60 to 98% by weight, and particularly preferably 70 to 97% by weight. In the case where the content of the (meth)acrylic resin in the forming material used for molding the polarizer protective film of the present invention is less than 50% byweight, high heat resistance and high transparency originally owned by the (meth)acrylic resin may not be reflected sufficiently.

The forming material used for molding the polarizer protective film of the present invention may contain a resin component other than the (meth)acrylic resin. As the resin component other than the (meth)acrylic resin, any appropriate resin component can be adopted as long as the effects of the present invention are not impaired.

### [A-2. Antioxidant]

In the polarizer protective film of the present invention, the forming material preferably contains an antioxidant whose weight reduction of 0.2 part by weight or more with respect to 100 parts by weight of the resin component in heating at 280° C. for 20 minutes is 10% or less.

The (meth)acrylic resin generally has a problem in that the decomposition thereof is accelerated at about 250° C. or higher to generate a (meth)acrylic monomer. Hitherto, the (meth)acrylic resin is formed generally at about 240° C. or lower (for example, JP 2005-82716 A, JP 2004-2835 A, JP 09-164638 A, JP 09-164638 A).

There is a demand for a polarizer protective film with less defects in outer appearance. In the case of using a resin material mainly containing a (meth)acrylic resin as a polarizer protective film material, in order to remove foreign matter and the like in the resin material causing defects in outer appearance, it is necessary to remove the foreign matter through a polymer filter when subjecting a forming material containing the resin material to extrusion molding to mold the polarizer protective film. In order to allow the forming material containing a resin material mainly containing a (meth)acrylic resin to pass through a polymer filter, it is necessary to sufficiently decrease the viscosity of the forming material containing the (meth)acrylic resin, and in order to decrease the viscosity sufficiently, it is necessary to increase the temperature of the (meth)acrylic resin during the passage of the polymer filter. However, if the temperature of the (meth)acrylic resin is increased, the decomposition is accelerated, with the result that a (meth)acrylic monomer is generated. The generation of the monomer causes foaming during the molding of the polarizer protective film, and the polarizer protective film thus obtained cannot be used.

By using a particular antioxidant in the polarizer protective film of the present invention, the decomposition of the (meth)acrylic resin is suppressed and the generation of radicals is suppressed. Consequently, the foaming and coloring caused when the radials attack a resin and various kinds of additives can be prevented. Further, due to the presence of an antioxidant, the coloring caused by a UV-absorbing monomer or a structural portion derived from the monomer at a high temperature can be prevented. The particular antioxidant refers to an antioxidant having particular conditions that “the weight reduction in heating at 280° C. for 20 minutes is 10% or less”.

By using a particular antioxidant in the polarizer protective film of the present invention, even when the forming temperature is set to be 250° C. or higher, the coloring of the polarizer protective film finally obtained, and the foaming in the polarizer protective film can be suppressed sufficiently.

The amount of the antioxidant is preferably 0.2 part by weight or more, more preferably 0.2 to 5 parts by weight, still more preferably 0.5 to 3 parts by weight, and particularly preferably 0.1 to 2.5 parts by weight with respect to 100 parts by weight of the resin component. When the amount of the antioxidant is less than 0.2 part by weight, the decomposition of the resin component (in particular, (meth)acrylic resin) may be accelerated. When the amount of the antioxidant is more than 5 parts by weight, the optical properties of the polarizer protective film to be obtained may be decreased.

The weight reduction of the antioxidant in heating at 280° C. for 20 minutes is 10% or less. A method of measuring the “weight reduction in heating at 280° C. for 20 minutes” is described later. It is preferred that the weight reduction of the antioxidant in heating at 280° C. for 20 minutes be as small as possible. The weight reduction in heating at 280° C. for 20 minutes is preferably 9% or less, more preferably 8% or less, still more preferably 6% or less, and particularly preferably 5% or less. In the case of using an antioxidant whose weight reduction in heating at 280° C. for 20 minutes is larger than 10%, the decomposition of a resin component (in particular, a (meth)acrylic resin) is accelerated during the molding of the polarizer protective film, which causes foaming, with the result that the polarizer protective film thus obtained may not be used.

In order to express the effects of the present invention additionally, it is preferred that the antioxidant contain a phenol-based antioxidant. As the phenol-based antioxidant, any appropriate phenol-based antioxidant may be employed. Examples thereof include n-octadecyl=3-(3,5-di-t-butyl-4-hydroxyphenyl)-propionate, n-octadecyl=3-(3,5-di-t-butyl-4-hydroxyphenyl)-acetate, n-octadecyl=3,5-di-t-butyl-4-hydroxybenzoate, n-hexyl=3,5-di-t-butyl-4-hydroxyphenylbenzoate, n-dodecyl=3,5-di-t-butyl-4-hydroxyphenylbenzoate, neo-dodecyl=3-(3,5-di-t-butyl-4-hydroxyphenyl)propionate, dodecyl=β(3,5-di-t-butyl-4-hydroxyphenyl)propionate, ethyl=α-(4-hydroxy-3,5-di-t-butylphenyl)isobutylate, octadecyl=α-(4-hydroxy-3,5-di-t-butylphenyl)isobutylate, octadecyl=α-(4-hydroxy-3,5-di-t-butyl-4-hydroxyphenyl)propionate, 2-(n-octylthio)ethyl=3,5-di-t-butyl-4-hydroxy-benzoate, 2-(n-octylthio)ethyl=3,5-di-t-butyl-4-hydroxy-phenylacetate, 2-(n-octadecylthio)ethyl=3,5-di-t-butyl-4-hydroxyphenylacetate, 2-(n-octadecylthio)ethyl=3,5-di-t-butyl-4-hydroxybenzoate, 2-(2-hydroxyethylthio)ethyl=3,5-di-t-butyl-4-hydroxybenzoate, diethylglycol=bis(3,5-di-t-butyl-4-hydroxy-phenyl)propionate, 2-(n-octadecylthio)ethyl=3-(3,5-di-t-butyl-4-hydroxyphenyl)propionate, stearamide-N,N-bis-[ethylene=3-(3,5-di-t-butyl-4-hydroxyphenyl)propionate], n-butylimino-N,N-bis-[ethylene=3-(3,5-di-t-butyl-4-hydroxyphenyl)propionate], 2-(2-stearoyloxyethylthio)ethyl=3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol=bis-[3-(3,5-di-t-butyl-4-hydroxyphenyl)propionate], ethylglycol=bis[3-(3,5-di-t-butyl-4-hydroxyphenyl)propionate], neopentylglycol=bis[3-(3 5-di-t-butyl-4-hydroxyphenyl)propionate], ethyleneglycol=bis(3,5-di-t-butyl-4-hydroxyphenylacetate), glycerin-1-n-octadecanoate-2,3-bis-(3,5-di-t-butyl-4-hydroxyphenylacetate), pentaerythritol-tetrakis-[3-(31,51-di-t-butyl-4′-hydroxyphenyl)propionate], 1,3,5-tris(3,5-di-t-butyl-4-hydroxybenzyl)-1,3,5-triazine-2,4,6(1H,3H,5H)-trione, 1,1,1-trimethylolethane-tris-[3-(3,5-di-t-butyl-4-hydroxyphenyl)propionate], sorbitol hexa-[3-(3,5-di-t-butyl-4-hydroxyphenyl)propionate], 2-hydroxyethyl=7-(3-methyl-5-t-butyl-4-hydroxyphenyl)propionate, 2-stearoyloxyethyl=7-(3-methyl-5-t-butyl-4-hydroxyphenyl)heptanoate, 1,6-n-hexanediol-bis[(3′,5′-di-t-butyl-4-hydroxyphenyl)propionate], pentaerythritol-tetrakis(3,5-di-t-butyl-4-hydroxycinnamate), and 3,9-bis[1,1-dimethyl-2-[β-(3-t-butyl-4-hydroxy-5-methylphenyl)propionyloxy]ethyl]2,4,8,10-tetraoxaspiro[5,5]-undecane. As the antioxidant having weight reduction of 10% or less in heating at 280° C. for 20 minutes, there are exemplified pentaerythritol-tetrakis-[3-(3′,5′-di-t-butyl-4′-hydroxyphenyl)propionate], 3,9-bis[1,1-dimethyl-2-[β-(3-t-butyl-4-hydroxy-5-methylphenyl)propionyloxy]ethyl]2,4,8,10-tetraoxaspiro[5,5]-undecane, and 1,3,5-tris(3,5-di-t-butyl-4-hydroxybenzyl)-1,3,5-triazine-2,4,6(1H,3H,5H)-trione.

In order to exhibit the effects of the present invention satisfactorily, it is more preferred that the antioxidant contain 0.1 part by weight or more of a phenol-based antioxidant and 0.1 part by weight or more of a thioether-based antioxidant with respect to 100 parts by weight of the resin component. It is much more preferred that the antioxidant contain 0.25 part by weight or more of the phenol-based antioxidant and 0.25 part by weight or more of the thioether-based antioxidant, and it is particularly preferred that the antioxidant contain 0.4 part by weight or more of the phenol-based antioxidant and 0.4 part by weight or more of the thioether-based antioxidant.

As the thioether-based antioxidant, any appropriate thioether-based antioxidant can be adopted. Examples thereof include pentaerythrityltetrakis(3-laurylthiopropionate), dilauryl-3,3′-thiodipropionate, dimyristyl-3,3′-thiodipropionate, and distearyl-3,3′-thiodipropionate. An example of the thioether-based antioxidant whose weight reduction in heating at 280° C. for 20 minutes is 10% or less includes pentaerythrityltetrakis(3-laurylthiopropionate).

In order to exhibit the effects of the present invention satisfactorily, it is preferred that the antioxidant contains 0.1 part by weight or more of a phenol-based antioxidant and 0.1 part by weight or more of a phosphorus-based antioxidant with respect to 100 parts by weight of the resin component. It is more preferred that the antioxidant contain 0.25 part by weight or more of the phenol-based antioxidant and 0.25 part by weight or more of the phosphorus-based antioxidant, and it is particularly preferred that the antioxidant contain 0.5 part by weight or more of the phenol-based antioxidant and 0.5 part by weight or more of the phosphorus-based antioxidant.

As the phosphorus-based antioxidant, any appropriate phosphorus-based antioxidant may be employed. Examples thereof include tris(2,4-di-t-butylphenyl)phosphite, 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine, diphenyltridecylphosphite, triphenylphosphite, 2,2-methylenebis(4,6-di-t-butylphenyl)octylphosphite, bis(2,6-di-t-butyl-4-methylphenyl)pentaerythritol diphosphite, distearyl pentaerythritol diphosphite, and cyclic neopentanetetraylbis(2,6-di-t-butyl-4-methylphenyl)phosphite. As the antioxidant having weight reduction of 10% or less in heating at 280° C. for 20 minutes, there is exemplified cyclic neopentanetetraylbis(2,6-di-t-butyl-4-methylphenyl)phosphite.

### [A-3. Forming Material]

The forming material used for obtaining the polarizer protective film of the present invention by extrusion molding contains the resin component, and preferably further contains the antioxidant. The forming material used in the present invention can contain any appropriate other components as long as the effects of the present invention are not impaired. For example, the forming material may contain general compounding agents, specifically, a stabilizer, a lubricant, a processing aid, a plasticizer, a impact-resistant aid, a retardation reducing agent, a flatting agent, an antimicrobial agent, and a fungicide.

### [A-4. Properties of Polarizer Protective Film]

The polarizer protective film of the present invention preferably has a high light transmittance, and preferably has a low in-plane retardation Δnd and a low thickness direction retardation Rth. The in-plane retardation Δnd can be obtained by Δnd=(nx−ny)×d. The thickness direction retardation Rth can be obtained by Rth=(nx−nz)×d. Herein, nx and ny are refractive indices in a plane in a slow axis direction and a fast axis direction, respectively, and nz is a thickness direction refractive index. The slow axis direction refers to a direction in which an in-plane refractive index becomes maximum.

The light transmittance at 380 nm in the thickness of 80 μm of the polarizer protective film of the present invention is 30% or less, preferably 25% or less, more preferably 20% or less, and still more preferably 15% or less, particularly preferably 10% or less, and most preferably 6% or less. When the light transmittance at 380 nm in the thickness of 80 μm of the polarizer protective film exceeds 30%, sufficient UV-absorbing ability may not be exhibited.

In the polarizer protective film of the present invention, YI in a thickness of 80 μm is preferably 1.27 or less, more preferably 1.25 or less, still more preferably 1.23 or less, and particularly preferably 1.20 or less. When the YI in the thickness of 80 μm exceeds 1.3, excellent optical transparency may not be exhibited. Note that the YI can be obtained, for example, by the following expression based on tristimulus values (X, Y, Z) of a color obtained by measurement, using a high-speed integrating-sphere spectral transmittance meter (DOT-3C (Trade name), manufactured by Murakami Color Research Laboratory Instruments).

YI=[(1.28X−1.06Z)/Y]×100

A b-value (scale of a hue in accordance with a Hunter-color system) in a thickness of 80 μm of the polarizer protective film of the present invention is preferably less than 1.5, and more preferably 1.0 or less. In the case where the b-value is 1.5 or more, excellent optical transparency may not be exhibited due to the coloring of a film. Note that the b-value can be obtained, for example, by cutting a polarizer protective film sample into pieces each having 3 cm per side and measuring the hue thereof using the high-speed integrating-sphere spectral transmittance meter (DOT-3C (Trade name), manufactured by Murakami Color Research Laboratory Instruments). The hue can be evaluated based on the b-value in accordance with the Hunter-color system.

In the polarizer protective film of the present invention, an in-plane retardation Δnd is preferably 3.0 nm or less and more preferably 1.0 nm or less. When the in-plane retardation Δnd exceeds 3.0 nm, the effects of the present invention, in particular, excellent optical properties may not be exhibited. A thickness direction retardation Rth is preferably 5.0 nm or less and more preferably 3.0 nm or less. When the thickness direction retardation Rth exceeds 5.0 nm, the effects of the present invention, in particular, excellent optical properties may not be exhibited. When the polarizer protective film of the present invention is placed between the polarizer and the liquid crystal cell, the retardation is preferably within the above range.

In the polarizer protective film of the present invention, moisture permeability is preferably 100 g/m²·24 hr or less and more preferably 60 g/m²·24 hr or less. When the moisture permeability exceeds 100 g/m²·24 hr, moisture resistance may be degraded.

The polarizer protective film of the present invention also preferably has excellent mechanical strength. The tensile strength in an MD direction is preferably 65 N/mm² or more, more preferably 70 N/mm² or more, still more preferably 75 N/mm² or more, and particularly preferably 80 N/mm² or more. The tensile strength in a TD direction is preferably 45 N/mm² or more, more preferably 50 N/mm² or more, still more preferably 55 N/mm² or more, and particularly preferably 60 N/mm² or more. The tensile elongation in an MD direction is preferably 6.5% or more, more preferably 7.0% or more, still more preferably 7.5% or more, and particularly preferably 8.0% or more. The tensile elongation in a TD direction is preferably 5.0% or more, more preferably 5.5% or more, still more preferably 6.0% or more, and particularly preferably 6.5% or more. In the case where the tensile strength or the tensile elongation is out of the above ranges, the excellent mechanical strength may not be exhibited.

The haze representing optical transparency of the polarizer protective film of the present invention is preferably as low as possible, and is preferably 5% or less, more preferably 3% or less, and still more preferably 1.5% or less, and particularly preferably 1% or less. When the haze is 5% or less, the film can be visually provided with satisfactory clear feeling. When the haze is 1.5% or less, even if the polarizer protective film is used as a lighting member such as a window, both visibility and lighting property can be obtained, and even if the polarizer protective film is used as a front plate of a display apparatus, display contents can be visually recognized satisfactorily. Thus, the polarizer protective film with such a haze has a high industrial use value.

The thickness of the polarizer protective film of the present invention is preferably 10 to 250 μm, more preferably 15 to 200 μm, still more preferably 30 to 180 μm, and particularly preferably 40 to 160 μm. When the thickness of the polarizer protective film of the present invention is 20 μm or more, the polarizer protective film has appropriate strength and stiffness, and hence has satisfactory handle ability during secondary processing such as lamination and printing. Further, the retardation caused by a stress during take-up can be controlled easily, and hence a film can be produced stably and easily. When the thickness of the polarizer protective film of the present invention is 200 μm or less, the film can be taken up easily, and the film has a high line speed and productivity and is easily controlled.

The polarizer protective film of the present invention can be used by being laminated on another base material. For example, the polarizer protective film can also be formed to be laminated on a base material made of glass, a polyolefin resin, an ethylene vinylidene copolymer to be a high barrier layer, or a polyester by multi-layer extrusion molding or multi-layer inflation molding including an adhesive resin layer. In the case where heat fusion property is high, an adhesion layer may be omitted.

The polarizer protective film of the present invention can be laminated on, for example, an architectural lighting member such as a window and a carport roof material, a vehicle lighting member such as a window, an agricultural lighting member such as a greenhouse, an illumination member, a display member such as a front filter, or the like, and can also be laminated on a housing of consumer electronics conventionally covered with a (meth)acrylic resin film, an interior member in a vehicle, an architectural material for interior finishing, a wallpaper, a decorative laminate, an entrance door, a window frame, a foot stall, or the like.

### [A-5. Forming of a Polarizer Protective Film]

The polarizer protective film of the present invention can be obtained by subjecting the forming material to extrusion molding (melt extrusion such as a T-die method and an inflation method) Specifically, it is preferred to perform biaxial kneading using direct adding or a master batch method. As a kneading method, it is preferred to perform kneading, using an extruder such as a uniaxial extruder or a biaxial extruder, a pressure kneader, or TEM manufactured by Toshiba Machine Co., Ltd. Further, the forming material previously blended by an omnimixer or the like may be kneaded.

In the present invention, by using, as a forming material for extrusion molding, a forming material that contains a resin component containing a (meth)acrylic resin obtained by polymerizing a monomer composition containing a UV-absorbing monomer and a (meth)acrylic monomer as a main component and that preferably contains a particular antioxidant in a particular ratio or more with respect to the resin component, as described above, the coloring and foaming in the polarizer protective film can be sufficiently suppressed finally even at a forming temperature of 250° C. or higher. Thus, it is preferred to set the temperature of the forming material during extrusion molding to be 250° C. or higher. The temperature of the forming material during extrusion molding is more preferably 250° C. or 300° C. When the temperature is too high, the decomposition of the (meth)acrylic resin may proceed easily.

According to the extrusion molding, it is not necessary to dry or splash a solvent in an adhesive used during processing, for example, an organic solvent in an adhesive for dry lamination unlike the dry lamination method, and hence the extrusion molding does not require the step of drying a solvent and is excellent in productivity.

In an example of a preferred embodiment of a forming method for obtaining the polarizer protective film of the present invention, a forming material is added to a biaxial kneader, the forming temperature is set to be at 250° C. or higher, the forming material is extruded to produce a resin pellet, the resin pellet thus obtained is supplied to a uniaxial extruder connected to a T-die, and the resin pellet is extruded at a die temperature of 250° C. or higher, whereby a polarizer protective film is obtained. The thickness of the polarizer protective film obtained by extrusion molding in the present invention is preferably 20 to 250 μm, more preferably 25 to 200 μm, still more preferably 30 to 180 μm, and particularly preferably 40 to 160 μm.

In the case of perform extrusion film molding by a T-die method, a T-die is attached to a tip end of any appropriate uniaxial extruder or biaxial extruder, and a film extruded in a film shape is taken up to obtain a film in a roll shape. At this time, the temperature of the take-up roll is adjusted appropriately and the film is stretched in an extrusion direction, whereby a uniaxial stretching step is provided. Further, the step such as sequential biaxial stretching or simultaneous biaxial stretching can also be added by adding the step of stretching the film in a direction perpendicular to the extrusion direction.

The polarizer protective film of the present invention may be stretched by longitudinal stretching and/or lateral stretching. The stretching may be stretching only by longitudinal stretching (free-end uniaxial stretching) or may be stretching only by lateral stretching (fixed-end uniaxial stretching). However, it is preferred that the stretching is sequential stretching or simultaneous biaxial stretching with a longitudinal stretching ratio of 1.1 to 3.0 times and a lateral stretching ratio of 1.1 to 3.0 times. In the stretching only by longitudinal stretching (free-end uniaxial stretching) or stretching only by lateral stretching (fixed-end uniaxial stretching), the film strength increases only in the stretching direction and the strength does not increase in a direction orthogonal to the stretching direction, with the result that sufficient film strength may not be obtained in the whole film. The longitudinal stretching ratio is preferably 1.2 to 2.5 times and more preferably 1.3 to 2.0 times. The lateral stretching ratio is more preferably 1.2 to 2.5 times and still more preferably 1.4 to 2.5 times. In the case where the longitudinal stretching ratio and the lateral stretching ratio are less than 1.1 times, the stretching ratio is too low, with the result that effects of the stretching may be hardly exhibited. When the longitudinal stretching ratio and the lateral stretching ratio exceed 3.0 times, stretching breakage is likely to occur due to the flatness of a film end face.

The stretching temperature is preferably Tg to (Tg+30° C.) of a film to be stretched. When the stretching temperature is lower than Tg, the film may be broken. When the stretching temperature exceeds (Tg+30° C.), the film may start melting and feeding of the film becomes difficult.

The polarizer protective film of the present invention is stretched by longitudinal stretching and/or lateral stretching, whereby the polarizer protective film has excellent optical properties and mechanical strength, and has enhanced productivity and rework property. The thickness of the stretched polarizer protective film is preferably 10 to 80 μm, and more preferably 15 to 60 μm.

### [B. Polarizing Plate]

The polarizing plate of the present invention includes the polarizer protective film of the present invention. The polarizing plate of the present invention is preferably a polarizing plate including a polarizer formed of a polyvinyl alcohol-based resin and the polarizer protective film of the present invention, and has the polarizer attached to the polarizer protective film via an adhesive layer.

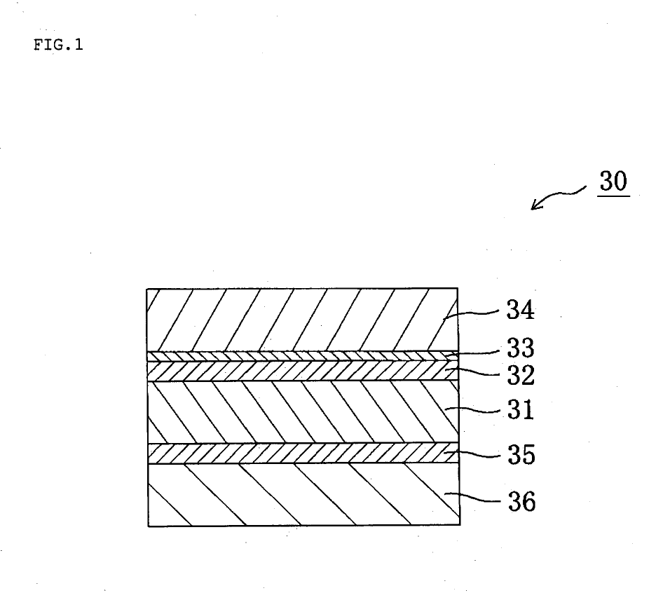

In one preferred embodiment of the polarizing plate of the present invention, as shown in FIG. 1, one surface of a polarizer 31 is attached to a polarizer protective film 34 of the present invention via an adhesive layer 32 and an easy adhesion layer 33, and the other surface of the polarizer 31 is attached to an optical film 36 via an adhesive layer 35. The optical film 36 may be the polarizer protective film of the present invention or any other suitable optical film.

The polarizer of the present invention, that is, the polarizer formed of a polyvinyl alcohol-based resin is generally manufactured by: coloring a polyvinyl alcohol-based resin film with a dichromatic substance (typically, iodine or a dichromatic dye); and uniaxially stretching the film. The polymerization degree of the polyvinyl alcohol-based resin for forming the polyvinyl alcohol-based resin film is preferably 100 to 5,000, and more preferably 1,400 to 4,000. The polyvinyl alcohol-based resin film for forming the polarizer may be formed by any appropriate method (such as a flow casting method involving film formation through flow casting of a solution containing a resin dissolved in water or an organic solvent, a casting method, or an extrusion method). The thickness of the polarizer may be appropriately set in accordance with the purpose and application of LCD employing the polarizing plate, but is typically 5 to 80 μm.

For producing a polarizer, any appropriate method may be employed in accordance with the purpose, materials to be used, conditions, and the like. Typically, employed is a method in which the polyvinyl alcohol-based resin film is subjected to a series of production steps including swelling, coloring, cross-linking, stretching, water washing, and drying steps. In each of the treatment steps excluding the drying step, the polyvinyl alcohol-based resin film is immersed in a bath containing a solution to be used in each step. The order, number of times, and absence or presence of swelling, coloring, cross-linking, stretching, water washing, and drying steps may be appropriately set in accordance with the purpose, materials to be used, conditions, and the like. For example, several treatments may be conducted at the same time in one step, or specific treatments may be omitted. More specifically, stretching treatment, for example, may be conducted after coloring treatment, before coloring treatment, or at the same time as swelling treatment, coloring treatment, and cross-linking treatment. Further, for example, cross-linking treatment can be preferably conducted before and after stretching treatment. Further, for example, water washing treatment may be conducted after each treatment or only after specific treatments.

The swelling step is typically conducted by immersing the polyvinyl alcohol-based resin film in a treatment bath (swelling bath) filled with water. This treatment allows washing away of contaminants from a surface of the polyvinyl alcohol-based resin film, washing away of an anti-blocking agent, and swelling of the polyvinyl alcohol-based resin film, to thereby prevent non-uniformity such as uneven coloring. The swelling bath may appropriately contain glycerin, potassium iodide, or the like. The temperature of the swelling bath is typically about 20 to 60° C., and the immersion time in the swelling bath is typically about 0.1 to 10 minutes.

The coloring step is typically conducted by immersing the polyvinyl alcohol-based resin film in a treatment bath (coloring bath) containing a dichromatic substance such as iodine. As a solvent to be used for a solution of the coloring bath, water is generally used, but an appropriate amount of an organic solvent having compatibility with water may be added. The dichromatic substance is typically used in a ratio of 0.1 to 1.0 part by weight with respect to 100 parts by weight of the solvent. In the case where iodine is used as a dichromatic substance, the solution in the coloring bath preferably further contains an assistant such as an iodide for improving a coloring efficiency. The assistant is used in a ratio of preferably 0.02 to 20 parts by weight, and more preferably 2 to 10 parts by weight with respect to 100 parts by weight of the solvent. Specific examples of the iodide include potassium iodide, lithium iodide, sodium iodide, zinc iodide, aluminum iodide, lead iodide, copper iodide, barium iodide, calcium iodide, tin iodide, and titanium iodide. The temperature of the coloring bath is typically about 20 to 70° C., and the immersion time in the coloring bath is typically about 1 to 20 minutes.

The cross-linking step is typically conducted by immersing in a treatment bath (cross-linking bath) containing a cross-linking agent the polyvinyl alcohol-based resin film that has undergone the coloring treatment. The cross-linking agent employed may be any appropriate cross-linking agent. Specific examples of the cross-linking agent include: a boron compound such as boric acid or borax; glyoxal; and glutaraldehyde. The cross-linking agent may be used alone or in combination. As a solvent to be used for a solution of the cross-linking bath, water is generally used, but an appropriate amount of an organic solvent having compatibility with water may be added. The cross-linking agent is typically used in a ratio of 1 to 10 parts by weight with respect to 100 parts by weight of the solvent. In the case where a concentration of the cross-linking agent is less than 1 part by weight, sufficient optical properties are often not obtained. In the case where the concentration of the cross-linking agent is more than 10 parts by weight, stretching force to be generated on the film during stretching increases and a polarizing plate to be obtained may shrink. The solution of the cross-linking bath preferably further contains an assistant such as an iodide for obtaining uniform properties in the same plane. The concentration of the assistant is preferably 0.05 to 15 wt %, and more preferably 0.5 to 8 wt %. Specific examples of the iodide are the same as in the case of the coloring step. The temperature of the cross-linking bath is typically about 20 to 70° C., and preferably 40 to 60° C. The immersion time in the cross-linking bath is typically about 1 second to 15 minutes, and preferably 5 seconds to 10 minutes.

The stretching step may be conducted at any stage as described above. Specifically, the stretching step may be conducted after the coloring treatment, before the coloring treatment, at the same time as the swelling treatment, the coloring treatment, and the cross-linking treatment, or after the cross-linking treatment. A cumulative stretching ratio of the polyvinyl alcohol-based resin film must be 5 times or more, preferably 5 to 7 times, and more preferably 5 to 6.5 times. In the case where the cumulative stretching ratio is less than 5 times, a polarizing plate having a high polarization degree may be hard to obtain. In the case where the cumulative stretching ratio is more than 7 times, the polyvinyl alcohol-based resin film (polarizer) may easily break. A specific method of stretching employed may be any appropriate method. For example, in the case where a wet stretching method is employed, a polyvinyl alcohol-based resin film is stretched in a treatment bath (stretching bath) to a predetermined ratio. A solution of the stretching bath to be preferably used is a solution in which various metal salts or compounds of iodine, boron, or zinc are added to a solvent such as water or an organic solvent (such as ethanol).

The water washing step is typically conduced by immersing in a treatment bath (water washing bath) the polyvinyl alcohol-based resin film that has undergone the various treatments. The water washing step allows washing away of unnecessary remains from the polyvinyl alcohol-based resin film. The water washing bath may contain pure water or an aqueous solution containing iodide (such as potassium iodide or sodium iodide). The concentration of an aqueous iodide solution is preferably 0.1 to 10 weight %. The aqueous iodide solution may contain an assistant such as zinc sulfate or zinc chloride. The temperature of the water washing bath is preferably 10 to 60° C. and more preferably 30 to 40° C., and the immersion time is typically 1 second to 1 minute. The water washing step may be conducted only once, or may be conducted a plurality of times as required. In the case where the water washing step is conducted a plurality of times, the kind and concentration of the additive contained in the water washing bath to be used for each treatment may appropriately be adjusted. For example, the water washing step includes a step of immersing a polymer film in an aqueous potassium iodide solution (0.1 to 10 weight %, 10 to 60° C.) for 1 second to 1 minute and a step of washing the polymer film with pure water.

The drying step may employ any appropriate drying method (such as natural drying, air drying, or heat drying). For example, in heat drying, a drying temperature is typically 20 to 80° C., and a drying time is typically 1 to 10 minutes. In such a manner as described above, the polarizer is obtained.

In the polarizing plate of the present invention, the polarizer is bonded to the polarizer protective film of the present invention via an adhesive layer.

In the present invention, the polarizer protective film and the polarizer of the present invention are bonded to each other via an adhesive layer formed of an adhesive. The adhesive layer is preferably formed of a polyvinyl alcohol-based adhesive because such an adhesive expresses a stronger adhesive property. The polyvinyl alcohol-based adhesive contains a polyvinyl alcohol-based resin and a cross-linking agent.

Examples of the polyvinyl alcohol-based resin include, without particular limitation: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft polymer, phosphate, or the like. Examples of the monomer include: unsaturated carboxylic acids such as maleic acid (anhydrides), fumaric acid, crotonic acid, itaconic acid, and (meth)acrylic acid and esters thereof; α-olefins such as ethylene and propylene; sodium(meth)allylsulfonate; sodium sulfonate(monoalkylmalate); sodium disulfonate alkylmalate; N-methylol acrylamide; alkali salts of acrylamide alkylsulfonate; N-vinylpyrrolidone; and derivatives of N-vinylpyrrolidone. The polyvinyl alcohol-based resins may be used alone or in combination.

The polyvinyl alcohol-based resin has, from the viewpoint of an adhesive property, an average polymerization degree of preferably 100 to 3,000 and more preferably 500 to 3,000, and an average saponification degree of preferably 85 to 100 mol % and more preferably 90 to 100 mol %.

A polyvinyl alcohol-based resin having an acetoacetyl group may be used as the polyvinyl alcohol-based resin. The polyvinyl alcohol-based resin having an acetoacetyl group is a highly reactive functional group and is preferred from the viewpoint of improving durability of a polarizing plate.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, in advance, and adding diketene thereto. Another example of the known method is a method involving directly bringing diketene gas or a liquid diketene into contact with polyvinyl alcohol.

A degree of acetoacetyl modification of the polyvinyl alcohol-based resin having an acetoacetyl group is not particularly limited as long as it is 0.1 mol % or more. A degree of acetoacetyl modification of less than 0.1 mol % provides insufficient water resistance with the adhesive layer and is inappropriate. The degree of acetoacetyl modification is preferably 0.1 to 40 mol % and more preferably 1 to 20 mol %. A degree of acetoacetyl modification of more than 40 mol % decreases the number of reaction sites with a cross-linking agent and provides a small effect of improving the water resistance. The degree of acetoacetyl modification is avalue measured by NMR.

As the cross-linking agent, the one used for a polyvinyl alcohol-based adhesive can be used without particular limitation. A compound having at least two functional groups each having reactivity with a polyvinyl alcohol-based resin can be used as the cross-linking agent. Examples of the compound include: alkylene diamines having an alkylene group and two amino groups such as ethylene diamine, triethylene diamine, and hexamethylene dimamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethanetriisocyanate), isophorone diisocyanate, and ketoxime blocked compounds or phenol blocked compounds thereof; epoxies such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylol urea, methylolmelamine, alkylated methylol urea, alkylated methylol melamine, acetoguanamine, or benzoguanamine; and salts of divalent or trivalent metals such as sodium, potassium, magnesium, calcium, aluminum, iron, and nickel and oxides thereof. A melamine-based cross-linking agent is preferred as the cross-linking agent, and methylolmelamine is particularly preferred.

A mixing amount of the cross-linking agent is preferably 0.1 to 35 parts by weight and more preferably 10 to 25 parts by weight with respect to 100 parts by weight of the polyvinyl alcohol-based resin. Meanwhile, for further improving the durability, the cross-linking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the cross-linking agent is preferably used in an amount of more than 30 parts by weight. The cross-linking agent is mixed within a range of more than 30 parts by weight and 46 parts by weight or less, to thereby improve the water resistance.

The polyvinyl alcohol-based adhesive can also contain a coupling agent such as a silane coupling agent or a titanium coupling agent, various kinds of tackifiers, a UV absorber, an antioxidant, a stabilizer such as a heat-resistant stabilizer or a hydrolysis-resistant stabilizer.

In the polarizer protective film of the present invention, the surface which comes into contact with a polarizer can be subjected to easy adhesion processing for the purpose of enhancing the adhesive property. Examples of the easy adhesion processing include surface treatments such as corona treatment, plasma treatment, low-pressure UV treatment, and saponification, and the formation of an anchor layer. They may be used in combination. Of those, the corona treatment, the formation of an anchor layer, and a combination thereof are preferred.

As the anchor layer, there is exemplified a silicone layer having a reactive functional group. Examples of a material for the silicone layer having a reactive functional group are not particularly limited and include alkoxysilanols each containing an isocyanate group, alkoxysilanols each containing an amino group, alkoxysilnaols each containing a mercapto group, alkoxysilanols each containing carboxyl group, alkoxysilanols each containing an epoxy group, alkoxysilanols each containing a vinyl-type unsaturated group, alkoxysilanols each containing a halogen group, and alkoxysilanols each containing an isocyanate group, and an amino-based silanol is preferred. Further, by adding a titanium-based catalyst or a tin-based catalyst for allowing the silanol to be reacted efficiently, the adhesive strength can be enhanced. Other additives may be added to the silicone containing a reactive functional group. Specifically, there may be further used a tackifier such as a terpene resin, a phenol resin, a terpene-phenol resin, a rosin resin, or a xylene resin, a UV absorber, an antioxidant, a stabilizer such as a heat-resistant stabilizer. Further, there is exemplified, as the anchor layer, a layer formed of the substance obtained by saponifying a cellulose acetate butylate resin.

The silicone layer having a reactive functional group is formed by coating and drying by a known technology. The thickness of the silicone layer after drying is preferably 1 to 100 nm and more preferably 10 to 50 nm. During coating, the silicone having a reactive functional group may be diluted with a solvent. An example of a dilution solvent is not particularly limited and includes alcohols. The dilution concentration is not particularly limited and is preferably 1 to 5% by weight and more preferably 1 to 3% by weight.

The adhesive layer is formed by applying the adhesive on one side or both sides of a polarizer protective film of the present invention, and on one side or both sides of a polarizer. After the polarizer protective film of the present invention and the polarizer are attached to each other, a drying step is performed, to thereby form an adhesive layer made of an applied dry layer. After the adhesive layer is formed, the polarizer and the polarizer protective film may also be attached to each other. The polarizer and the polarizer protective film of the present invention are attached to each other with a roll laminator or the like. The heat-drying temperature and the drying time are appropriately determined depending upon the kind of an adhesive.

Too large thickness of the adhesive layer after drying is not preferred in view of the adhesive property of the polarizer protective film of the present invention. Therefore, the thickness of the adhesive layer is preferably 0.01 to 10 μm, and more preferably 0.03 to 5 μm.

The attachment of the polarizer protective film of the present invention to the polarizer can be performed by bonding both surfaces of the polarizer to one side of the polarizer protective film of the present invention.

Further, the attachment of the polarizer to the polarizer protective film of the present invention can be performed by bonding one surface of the polarizer to one side of the polarizer protective film of the present invention and attaching a cellulose-based resin to the other side of the polarizer protective film of the present invention.

The cellulose-based resin is not particularly limited. However, triacetyl cellulose is preferred in terms of transparency and an adhesive property. The thickness of the cellulose-based resin is preferably 30 to 100 μm and more preferably 40 to 80 μm. When the thickness is smaller than 30 μm, the film strength decreases to degrade workability, and when the thickness is larger than 100 μm, the light transmittance decreases remarkably in terms of durability.

The polarizing plate of the present invention may have a pressure-sensitive adhesive layer as at least one of an outermost layer (such a polarizing plate may be referred to as polarizing plate of a pressure-sensitive adhesion type). As a particularly preferred embodiment, a pressure-sensitive adhesive layer for bonding with other members such as another optical film and a liquid crystal cell can be provided to an opposite side of the polarizer protective film of the present invention to which the polarizer is bonded.

The pressure-sensitive adhesive forming the pressure-sensitive adhesive layer is not particularly limited. However, for example, a pressure-sensitive adhesive containing as a base polymer an acrylic polymer, a silicone-based polymer, polyester, polyurethane, polyamide, polyether, a fluorine or rubber-based polymer can be appropriately selected to be used. In particular, a pressure-sensitive adhesive such as an acrylic pressure-sensitive adhesive is preferably used, which is excellent in optical transparency, exhibits appropriate wettability and pressure-sensitive adhesion properties of a cohesive property and an adhesive property, and is excellent in weather resistance and heat resistance. In particular, an acrylic pressure-sensitive adhesive made of an acrylic polymer having 4 to 12 carbon atoms is preferred.

In addition to the above, in terms of the prevention of a foaming phenomenon and a peeling phenomenon caused by moisture absorption, the prevention of a degradation in optical properties and bending of a liquid crystal cell caused by thermal expansion difference or the like, and the formation property of a liquid crystal display apparatus which is of high quality and has excellent durability, a pressure-sensitive adhesive layer having a low moisture absorbing ratio and excellent heat resistance is preferred.

The pressure-sensitive adhesive layer may contain, for example, resins of a natural substance or a synthetic substance, in particular, additives to be added to the pressure-sensitive adhesive layer including a tackifying resin, a filler such as glass fibers, glass beads, metal powder, or other inorganic powders, a pigment, a colorant, and an antioxidant.

Further, a pressure-sensitive adhesive layer that contains fine particles and exhibits a light diffusion property or the like may be used.

The pressure-sensitive adhesive layer can be provided by any appropriate method. Examples thereof include a method involving preparing a pressure-sensitive adhesive solution in an amount of about 10 to 40% by weight in which a base polymer or a composition thereof is dissolved or dispersed in any appropriate single solvent such as toluene or ethyl acetate or a solvent made of a mixture, and directly providing the pressure-sensitive adhesive solution onto a polarizing plate or a polarizer protective film by any appropriate development method such as a flow casting method or a coating method, or a method involving forming a pressure-sensitive adhesive layer on a separator according to the above, and moving the pressure-sensitive adhesive layer to the polarizer protective film surface.

The pressure-sensitive adhesive layer may also be provided on one surface or both surfaces of a polarizing plate as superimposed layers of different compositions, different kinds, or the like. In the case of providing the pressure-sensitive adhesive layer on both surfaces of the polarizing plate, pressure-sensitive adhesive layers on front and reverse surfaces of the polarizing plate can have different compositions, kinds, thicknesses, and the like.

The thickness of the pressure-sensitive adhesive layer can be determined appropriately in accordance with the use purpose and the adhesive strength, and is preferably 1 to 40 μm, more preferably 5 to 30 μm, and particularly preferably 10 to 25 μm. When the thickness of the pressure-sensitive adhesive layer is smaller than 1 μm, durability of the layer degrades. When the thickness of the pressure-sensitive adhesive layer is larger than 40 μm, lifting and peeling are likely to occur due to foaming or the like, resulting in an unsatisfactory outer appearance.

In order to enhance the adhesiveness between the polarizer protective film of the present invention and the pressure-sensitive adhesive layer, an anchor layer can also be provided therebetween.

As the anchor layer, preferably, an anchor layer selected from polyurethane, polyester, and polymers containing amino groups in molecules is used, and in particular, polymers containing amino groups in molecules are preferably used. In the polymer containing an amino group in molecules, an amino group in the molecules reacts with a carboxyl group in the pressure-sensitive adhesive or a polar group in a conductive polymer, or exhibits an interaction such as an ion interaction, so satisfactory adhesiveness is ensured.

Examples of the polymers containing amino groups in molecules include polyethyleneimine, polyallylamine, polyvinylamine, polyvinylpyridine, polyvinylpyrrolidine, and a polymer of an amino group-containing monomer such as dimethylaminoethyl acrylate shown in the copolymerized monomer of the acrylic pressure-sensitive adhesive.

In order to provide the anchor layer with an antistatic property, an antistatic agent can also be added. Examples of the antistatic agent for providing an antistatic property include an ionic surfactant, a conductive polymer such as polyaniline, polythiophene, polypyrrole, or polyquinoxaline, and a metal oxide such as tin oxide, antimony oxide, or indium oxide. In particular, in view of optical properties, an outer appearance, an antistatic effect, and stability of an antistatic effect under heat or humidity, the conductive polymers are used preferably. Of those, a water-soluble conductive polymer such as polyaniline or polythiophene, or a water-dispersion conductive polymer is particularly preferably used. The reason for this is as follows: in the case of using a water-soluble conductive polymer or a water-dispersion conductive polymer as a forming material of an antistatic layer, the deterioration of a polarizer protective film base material caused by an organic solvent can be suppressed in the process of coating.

In the present invention, each layer of a polarizer and an optical film (polarizer protective film and the like) forming the polarizing plate, and the pressure-sensitive adhesive layer may be provided with a UV-absorbing ability, for example, by the treatment with a UV absorber such as a salicylate-based compound, a benzophenol-based compound, benzotriazol-based compound, a cyanoacrylate-based compound, and a nickel complex salt-based compound.

The polarizing plate of the present invention may be provided on one of a viewer side and a backlight side of a liquid crystal cell or on both sides thereof without particular limitation.

### [C. Image Display Apparatus]

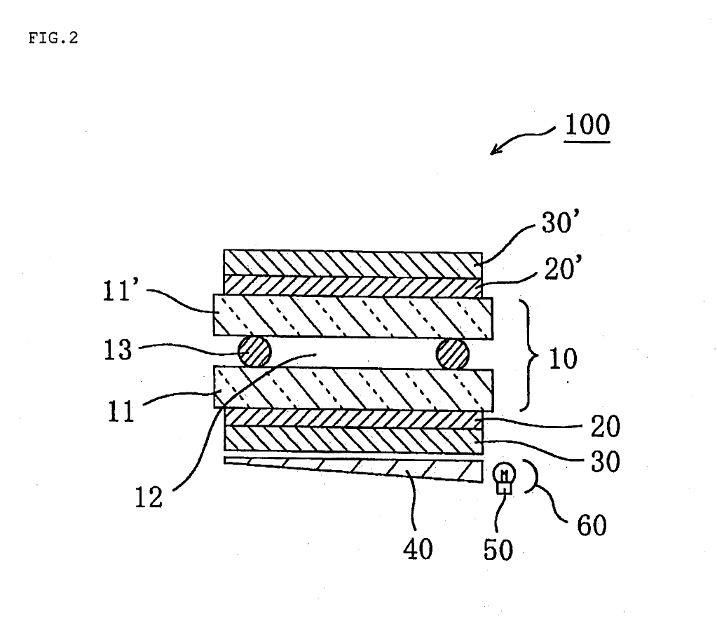

Next, an image display apparatus of the present invention is described. The image display apparatus of the present invention includes at least one polarizing plate of the present invention. Herein, as one example, a liquid crystal display apparatus is described. However, it is needless to say that the present invention is applicable to any display apparatus requiring a polarizing plate. Specific examples of the image display apparatus to which the polarizing plate of the present invention is applicable include a self-emitting display apparatus such as an electroluminescence (EL) display, a plasma display (PD), and a field emission display (FED). FIG. 2 is a schematic cross-sectional view of a liquid crystal display apparatus according to a preferred embodiment of the present invention. In the illustrated example, a transmission-type liquid crystal display apparatus is described. However, it is needless to say that the present invention is also applicable to a reflection-type liquid crystal display apparatus or the like.

A liquid crystal display apparatus 100 includes a liquid crystal cell 10, retardation films 20 and 20′ placed so as to interpose the liquid crystal cell 10 therebetween, polarizing plates 30 and 30′ placed on outer sides of the retardation films 20 and 20′, a light guide plate 40, a light source 50, and a reflector 60. The polarizing plates 30 and 30′ are placed so that polarization axes thereof are perpendicular to each other. The liquid crystal cell 10 includes a pair of glass substrates 11 and 11′ and a liquid crystal layer 12 as a display medium placed between the substrates. One glass substrate 11 is provided with a switching element (typically, TFT) for controlling the electrooptical properties of liquid crystals, a scanning line for providing a gate signal to the switching element, and a signal line for providing a source signal to the switching element (all of them are not shown). The other glass substrate 11′ is provided with a color layer forming a color filter and a shielding layer (black matrix layer) (both of them are not shown). A distance (cell gap) between the glass substrates 11 and 11′ is controlled by a spacer 13. In the liquid crystal display apparatus of the present invention, the polarizing plate of the present invention described above is employed as at least one of the polarizing plates 30 and 30′.

For example, in the case of the liquid crystal display apparatus 100 employing a TN mode, liquid crystal molecules of the liquid crystal layer 12 are aligned in a state with respective polarization axes being shifted by 90° during no voltage application. In such a state, incident light including light in one direction transmitted through the polarizing plate is twisted 90° by the liquid crystal molecules. As described above, the polarizing plates are arranged such that the respective polarization axes are perpendicular to each other, and thus light (polarized light) reaching the other polarizing plate transmits through the polarizing plate. Thus, during no voltage application, the liquid crystal display apparatus 100 provides a white display (normally white mode). Meanwhile, in the case where a voltage is applied onto the liquid crystal display apparatus 100, alignment of the liquid crystal molecules in the liquid crystal layer 12 changes. As a result, the light (polarized light) reaching the other polarizing plate cannot transmit through the polarizing plate, and a black display is provided. Displays are switched as described above by pixel by using the active element, to thereby form an image.

### Examples

Hereinafter, the present invention is described specifically with reference to Examples, but the present invention is not limited to the examples. Unless otherwise noted, “%” in the Examples and Comparative Examples refers to parts by weight. Evaluations were performed as follows.

### <Weight Average Molecular Weight>

The weight average molecular weight of a polymer was obtained by polystyrene conversion of GPC (GPC system manufactured by Tosoh Corporation). As an eluent, chloroform was used.

### <Thermal Analysis of Resin>

The thermal analysis of a resin was performed using about 10 mg of a sample under the conditions of a rate of temperature rise of 10° C./min and a nitrogen flow of 50 cc/min, using DSC (apparatus name: DSC-8230, manufactured by Rigaku Corporation). The glass transition temperature (Tg) was obtained by a middle point scheme in accordance with ASTM-D-3418.

### <Content Ratio of Lactone Ring Structure Unit>

First, the dealcoholization reaction rate was obtained from the weight reduction caused by a dealcoholization reaction from 150° C., which is prior to the starting of the weight reduction, to 300° C., which is prior to the starting of the decomposition of a polymer, by dynamic TG measurement, based on the weight reduction amount occurring at a time when all the hydroxyl groups are dealcoholized as methanol from a polymer composition obtained in polymerization.

More specifically, the weight reduction rate from 150° C. to 300° C. by the dynamic TG measurement of a polymer having a lactone ring structure is measured, and the obtained measured weight reduction rate is defined as (X). On the other hand, the theoretical weight reduction rate (i.e., weight reduction rate calculated assuming that 100% dealcoholization occurred on the composition) assuming that all the hydroxyl groups contained in the polymer composition participate in the formation of a lactone ring to become alcohol, resulting in dealcoholization, from the polymer composition, is defined as (Y). More specifically, the theoretical weight reduction rate (Y) can be calculated from a molar ratio of a raw material monomer having a structure (hydroxyl group) participating in a dealcoholization reaction in a polymer, that is, the content of the raw material monomer in the polymer composition. Those values (X, Y) are substituted into a dealcoholization calculation expression:

1−(measured weight reduction rate (X)/theoretical weight reduction rate (Y)),

and the obtained value is expressed by %, to thereby obtain a dealcoholization reaction rate.

As an example, the ratio at which the lactone ring structure occupies in a pellet obtained in Reference Example 3 described later is calculated. The theoretical weight reduction rate (Y) of the polymer is obtained as follows. The molecular weight of methanol is 32, the molecular weight of methyl 2-(hydroxymethyl)acrylate is 116, and the content ratio (weight ratio) of methyl 2-(hydroxymethyl)acrylate in the polymer is 20% by weight or more in terms of the composition, and hence the theoretical weight reduction rate (Y) is (32/116)×20≈5.52% by weight. On the other hand, the measured weight reduction rate (X) by the dynamic TG measurement was 0.18% by weight. If those values are substituted in the above dealcoholization formula, 1−(0.18/5.52)≈0.967, and hence, the dealcoholization ratio is 96.7% by weight.

Then, assuming that predetermined lactone cyclization is performed by the dealcoholization reaction rate, the content ratio (weight ratio) in the copolymer composition of a material monomer having a structure (hydroxyl group) participating in lactone cyclization is multiplied by the dealcoholization reaction rate and converted into a content ratio (weight ratio) of a structure of a lactone ring unit, whereby the content ratio of the lactone ring structure in the copolymer can be calculated. In the case of Reference Example 3, the content of methyl 2-(hydroxymethyl)acrylate in the copolymer is 20.0% by weight, the calculated dealcoholization reaction rate is 96.7% by weight, and the formula weight of a lactone cyclization structure unit generated in the case where methyl 2-(hydroxymethyl)acrylate with a molecular weight of 116 is condensed with methyl methacrylate is 170. Thus, the content ratio of a lactone ring in the copolymer is 28.3% by weight ((20.0×0.967×170/116)% by weight).

### <Weight Reduction in Heating at 280° C. for 20 Minutes>

The weight reduction in heating at 280° C. for 20 minutes was evaluated based on the weight reduction rate in the case of heating at 280° C. for 20 minutes in a nitrogen stream. The weight reduction was measured in a nitrogen stream by a thermogravimetric analysis apparatus (TG/DTA6200manufactured by Seiko Instruments Inc.) using about 5 to 10 mg of a sample. The sample was raised in temperature to 280° C. at 10° C./min and held at 280° C. for 20 minutes. The weight reduction was calculated by the following Expression:

M=(M1−M0)/M0

where M0 is the weight before processing, M1 is the weight after the processing, and M is the weight reduction rate (%).
<Light Transmittance at 380 nm>

A film sample was cut to 3 cm per side, and the light transmittance thereof at 380 nm was measured by “UV-VIS-NIR-SPECTROMETER UV3150” (Examples 1 to 3, Comparative Example 1) or “UV-3100” (Examples 5 to 15, Comparative Example 2) manufactured by Shimadzu Corporation.

### <B-Value>

A film sample was cut to 3 cm per side, and the hue thereof was measured using a high-speed integrating-sphere spectral transmittance meter (Trade name: DOT-3C, manufactured by Murakami Color Research Laboratory Instruments). The hue was evaluated based on the b-value in accordance with a Hunter-color system.

### <Coloring Evaluation By Heating>

The obtained resin pellet was heated at 280° C. for 20 minutes in a nitrogen atmosphere. The color of the resin pellet before heating was compared with the color of the resin pellet after heating.

× . . . Yellowing increased.

∘ . . . Almost no change (almost no coloring).

⊚ . . . No change (no coloring).

### <Coloring Degree (YI) of Resin>

The coloring degree (YI) of a resin was obtained by dissolving a resin in chloroform, placing 15% by weight of the mixture in a quartz cell, and measuring the coloring degree with transmitted light using a colorimeter (apparatus name: SZ-Σ90, manufactured by Nippon Denshoku Industries Co., Ltd.) in accordance with JIS-K-7103.

### <Observation of Presence/Absence of Foaming>

A resin was extruded from a T-die at a die temperature of 290° C. by a uniaxial extruder, and the resin extruded from the T-die was observed to find out the presence/absence of foaming.

×× . . . Many foamings with a diameter (longer diameter in the case of an oval shape) of 0.5 mm or more are observed over the entire surface.

× . . . Foamings with a diameter (longer diameter in the case of an oval shape) of 0.5 mm or more are observed over the entire surface.

∘ . . . Foamings with a diameter of 0.5 mm or less are observed.

⊚ . . . No foamings are observed by visual inspection.

### <Method of Evaluating Resistance to Thermal Decomposition>

1 g of a resin was placed in a test tube, and the test tube was inserted in a heat block (DRY-BLOCK-Bath manufactured by SCINICS Corporation) raised in temperature to 260° C. After the test tube was held as it was for 30 minutes, the test tube was taken out, and the decomposition and foaming of the resin were observed by visual inspection. The resistance to thermal decomposition was determined based on the following state observation standards.

× . . . Coloring and foaming are remarkable. The increase in a bubble surface by foaming is large.

Δ . . . Coloring and foaming are found. The bubble surface by foaming is increased.

∘ . . . No coloring and foaming are found, or the degree thereof is small if any coloring and foaming are found.

### Reference Example 1

### Manufacturing Method for Polarizer

A polyvinyl alcohol film with a thickness of 80 μm was dyed in a 5% by weight of an iodine aqueous solution (weight ratio: iodine/potassium iodide=1/10). Then, the resultant polyvinyl alcohol film was immersed in an aqueous solution containing 3% by weight of boric acid and 2% by weight of potassium iodide. Further, the polyvinyl alcohol film was stretched by 5.5 times in an aqueous solution containing 4% by weight of boric acid and 3% by weight of potassium iodide, and thereafter, the polyvinyl alcohol film was immersed in a 5% by weight of a potassium iodide aqueous solution. After that, the polyvinyl alcohol film was dried in an oven at 40° C. for 3 minutes to obtain a polarizer with a thickness of 30 μm.

### Reference Example 2

### Production of Lactone Ring-Containing Acrylic Resin (Using a UV-Absorbing Monomer)

In a 30-L reaction vessel equipped with a stirring device, a temperature sensor, a cooling pipe, and a nitrogen introduction pipe, 7,000 g of methyl methacrylate (MMA), 1,000 g of 2-[2′-hydroxy-5′-(methacryloloxyethyl)phenyl]benzotriazole, 2,000 g of methyl 2-(hydroxymethyl)acrylate (MHMA), and 10,000 g of toluene were placed, and the mixture was heated to 105° C. while nitrogen was being introduced thereto. After reflux, while 10.0 g of tert-amylperoxy isononanoate (Lupasol 570 (Trade name) manufactured by Arkema Yoshitomi Ltd.) was added as an initiator, and at the same time, a solution containing 20.0 g of the initiator and 100 g of toluene were dropped over 4 hours, the mixture was subjected to solution polymerization under reflux (about 105 to 110° C.), and further aged over 4 hours.

To the resultant polymer solution, 10 g of a stearyl phosphate/distearyl phosphate mixture (Phoslex A-18 (Trade name) manufactured by Sakai Chemical Industry Co., Ltd.) was added, and the polymer solution was subjected to cyclization condensation under reflux (about 90 to 110° C.) for 5 hours. Then, the polymer solution obtained in the above cyclization condensation was introduced to a bent-type screw biaxial extruder (Φ=29.75 mm, L/D=30) of a barrel temperature of 260° C., a rotation number of 100 rpm, a decompression degree of 13.3 to 400 hPa (10 to 300 mmHg), one rear bent, and four fore bents, at a processing speed of 2.0 kg/hour in terms of a resin amount. The polymer solution was subjected to cyclization condensation reaction and devolatilization in the extruder and extruded, to thereby obtain a transparent lactone ring-containing acrylic resin pellet (A).

The lactone cyclization ratio of the lactone ring-containing acrylic resin pellet (A) was 97.0%.

### Reference Example 3

### Production of Lactone Ring-Containing Acrylic Resin (Without Using a UV-Absorbing Monomer)

In a 30-L reaction vessel equipped with a stirring device, a temperature sensor, a cooling pipe, and a nitrogen introduction pipe, 8,000 g of methyl methacrylate (MMA), 2,000 g of methyl 2-(hydroxymethyl)acrylate (MHMA), and 10,000 g of toluene were placed, and the mixture was heated to 105° C. while nitrogen was being introduced thereto. After reflux, while 10.0 g of tert-amylperoxy isononanoate (Lupasol 570 (Trade name) manufactured by Arkema Yoshitomi Ltd.) was added as an initiator, and at the same time, a solution containing 20.0 g of the initiator and 100 g of toluene were dropped over 4 hours, the mixture was subjected to solution polymerization under reflux (about 105 to 110° C.), and further aged over 4 hours.

To the resultant polymer solution, 10 g of a stearyl. phosphate/distearyl phosphate mixture (Phoslex A-18 (Trade name) manufactured by Sakai Chemical Industry Co., Ltd.) was added, and the polymer solution was subjected to cyclization condensation under reflux (about 90 to 110° C.) for 5 hours. Then, the polymer solution obtained in the above cyclization condensation was introduced to a bent-type screw biaxial extruder (Φ=29.75 mm, L/D=30) of a barrel temperature of 260° C., a rotation number of 100 rpm, a decompression degree of 13.3 to 400 hPa (10 to 300 mmHg), one rear bent, and four fore bents, at a processing speed of 2.0 kg/hour in terms of a resin amount. The polymer solution was subjected to cyclization condensation reaction and devolatilization in the extruder and extruded, to thereby obtain a transparent lactone ring-containing acrylic resin pellet (B).

The lactone cyclization ratio of the lactone ring-containing acrylic resin pellet (B) was 96.7%.

### Example 1

To 100 parts by weight of the lactone ring-containing acrylic resin pellet (A) obtained in Reference Example 2, one part by weight of a phosphorus-based antioxidant (PEP-36 manufactured by ADEKA Corporation) and one part by weight of a phenol-based antioxidant (IRGANOX 1010 manufactured by Ciba Specialty Chemicals Inc.) were mixed by a biaxial kneader at 230° C. to produce a resin pellet.

The weight reduction of each used additive in heating at 280° C. for 20 minutes was as follows: the phosphorus-based antioxidant (PEP-36 manufactured by ADEKA Corporation)=7.9% and the phenol-based antioxidant (IRGANOX 1010 manufactured by Ciba Specialty Chemicals Inc.)=4.2%.

The obtained resin pellet (1) was evaluated for coloring by heating. Table 1 shows the results.

The obtained resin pellet (1) was dried at 800 Pa (6 Torr) and 100° C. for 12 hours, and extruded from a T-die at a die temperature of 290° C. by a uniaxial extruder to produce a polarizer protective film (1) with a thickness of 80 μm.

The presence/absence of foaming was observed in the obtained polarizer protective film (1). Table 1 shows the results.

The light transmittance at 380 nm of the obtained polarizer protective film (1) in a thickness of 80 μm was measured and the b-value in a thickness of 80 μm was measured. Table 1 shows the results.

### Example 2

To 100 parts by weight of the lactone ring-containing acrylic resin pellet (A) obtained in Reference Example 2, one part by weight of a thioether-based antioxidant (sumilizer-TP-D manufactured by Sumitomo Chemical Co., Ltd.) and one part by weight of a phenol-based antioxidant (IRGANOX 1010 manufactured by Ciba Specialty Chemicals Inc.) were mixed by a biaxial kneader at 230° C. to produce a resin pellet (2).

The weight reduction of each used additive in heating at 280° C. for 20 minutes was as follows: the thioether-based antioxidant (sumilizer-TP-D manufactured by Sumitomo Chemical Co., Ltd.)=2.4% and the phenol-based antioxidant (IRGANOX 1010 manufactured by Ciba Specialty Chemicals Inc.)=4.2%.

The obtained resin pellet (2) was evaluated for coloring by heating. Table 1 shows the results.

The obtained resin pellet (2) was dried at 800 Pa (6 Torr) and 100° C. for 12 hours, and extruded from a T-die at a die temperature of 290° C. by a uniaxial extruder to produce a polarizer protective film (2) with a thickness of 80 μm.

The presence/absence of foaming was observed in the obtained polarizer protective film (2). Table 1 shows the results.

The light transmittance at 380 nm of the obtained polarizer protective film (2) in a thickness of 80 μm was measured and the b-value in a thickness of 80 μm was measured. Table 1 shows the results.

### Example 3

The lactone ring-containing acrylic resin pellet (A) obtained in Reference Example 2 as it was used as a resin pellet (3).

The obtained resin pellet (3) was evaluated for coloring by heating. Table 1 shows the results.

The obtained resin pellet (3) was dried at 800 Pa (6 Torr) and 100° C. for 12 hours, and extruded from a T-die at a die temperature of 250° C. by a uniaxial extruder to produce a film with a thickness of 120 μm. The film was stretched in a longitudinal direction at 140° C. by 1.5 times, and thereafter, stretched in a lateral direction at 140° C. by 1.3 times to produce a polarizer protective film (3) with a thickness of 80 nm.

The presence/absence of foaming was observed in the obtained polarizer protective film (3). Table 1 shows the results.

The light transmittance at 380 nm of the obtained polarizer protective film (3) in a thickness of 80 μm was measured and the b-value in a thickness of 80 μm was measured. Table 1 shows the results.

### Comparative Example 1

The lactone ring-containing acrylic resin pellet (B) obtained in Reference Example 3 was used as a resin pellet (C1).

The obtained resin pellet (C1) was evaluated for coloring by heating. Table 1 shows the results.

The obtained resin pellet (C1) was dried at 800 Pa (6 Torr) and 100° C. for 12 hours, and extruded from a T-die at a die temperature of 290° C. by a uniaxial extruder to produce a polarizer protective film (C1) with a thickness of 80 μm.

The presence/absence of foaming was observed in the obtained polarizer protective film (C1). Table 1 shows the results.

The light transmittance at 380 nm of the obtained polarizer protective film (C1) in a thickness of 80 μm was measured and the b-value in a thickness of 80 μm was measured. Table 1 shows the results.

TABLE 1

| | | Observation | | |
|---|---|---|---|---|
| | Coloring | results of | Light | |
| | evaluation of | presence/absence | transmittance | |
| | resin pellet | of foaming | at 380 nm (%) | b value |
| Example 1 | ⊚ | ⊚ | 0.01 | 1.2 |
| Example 2 | ⊚ | ⊚ | 0.01 | 1.3 |
| Example 3 | ◯ | ◯ | 0.01 | 5 |
| Comparative | X | XX | 90.57 | 0.726 |
| Example 1 | | | | |

### Example 4

### (Adhesive)

An aqueous solution of a polyvinyl alcohol-based adhesive was prepared by adding an aqueous solution containing 20 parts by weight of methylol melamine with respect to 100 parts by weight of a polyvinyl alcohol resin with a denatured acetoacetyl group (acetylation degree: 13%) so as to be a concentration of 0.5% by weight.

### (Production of Polarizing Plate)

The polarizer protective film (1) obtained in Example 1 was attached to both surfaces of the polarizer obtained in Reference Example 1 using a polyvinyl alcohol-based adhesive. The polyvinyl alcohol-based adhesive was applied onto acrylic resin surface sides, followed by drying at 70° C. for 10 minutes, to obtain a polarizing plate.

### (Pressure-Sensitive Adhesive)

As a base polymer, a solution (solid content: 30%) containing an acrylic polymer with a weight average molecular weight of 2,000,000 made of a copolymer of butyl acrylate:acrylic acid:2-hydroxyethyl acrylate=100:5:0.1 (weight ratio) was used. To the acrylic polymer solution, 4 parts of COLONATE L manufactured by Nippon Polyurethane Co., Ltd., which was an isocyanate-based polyfunctional compound, 0.5 part of an additive (KBM 403 manufactured by Shin-Etsu Chemical Co., Ltd.), and a solvent (ethyl acetate) for adjusting the viscosity were added with respect to 100 parts of a polymer solid content, to thereby prepare the pressure-sensitive adhesive solution (solid content: 12%). The pressure-sensitive adhesive solution was applied onto a releasing film so that the thickness of the layer was 25 μm after drying (polyethylene terephthalate base material: Dia Foil MRF38 manufactured by Mitsubishi Chemical Polyester Film Co., Ltd.), followed by drying in a hot-air circulation type oven, to thereby form a pressure-sensitive adhesive layer.

### (Polarizing Plate Anchor Layer)

A polyethyleneimine adduct of polyacrylate (Polyment NK380 manufactured by Nippon Shokubai Co., Ltd.) was diluted 50-fold with methylisobutylketone. The resultant polyethyleneimine adduct was applied onto a nylon resin side of the polarizing plate using a wire bar (#5) so that the thickness after drying was 50 nm, followed by drying.

### (Production of a Pressure-Sensitive Adhesive Type Polarizing Plate)

A releasing film with the pressure-sensitive adhesive layer formed thereon was attached to the polarizing plate anchor layer, to thereby produce a pressure-sensitive adhesive type polarizing plate.

### (Evaluation of Polarizing Plate)

The adhesive property between the film and the polarizer of the obtained polarizing plate, and the outer appearance thereof were evaluated, revealing that the adhesive property was favorable and the polarizer and the film were integrated with each other and did not peel from each other, and there was no defect in the outer appearance.

### Example 5

In a 30-L reaction vessel equipped with a stirring device, a temperature sensor, a cooling pipe, and a nitrogen introduction pipe, 37.5 parts of methyl methacrylate (MMA), 10 parts of methyl 2-(hydroxymethyl)acrylate (MHMA), 2.5 parts by weight of 2-[2′-hydroxy-5′-(methacryloyloxyethyl)phenyl]-2H-benzotriazole (RUVA-93 (Trade name) manufactured by OTSUKA Chemical Co., Ltd.), and 50 parts of toluene were placed, and the mixture was heated to 105° C. while nitrogen was being introduced thereto. After reflux, while 0.05 part of tert-amylperoxy isononanoate (Lupasol 570 (Trade name) manufactured by Arkema Yoshitomi Ltd.) was added as an initiator, and at the same time, 0.10 part of tert-amylperoxy isononanoate was dropped over 2 hours, the mixture was subjected to solution polymerization under reflux (about 105 to 110° C.), and further aged over 4 hours.

To the resultant polymer solution, 0.05 part of a stearyl phosphate/distearyl phosphate mixture (Phoslex A-18 (Trade name) manufactured by Sakai Chemical Industry Co., Ltd.) was added, and the polymer solution was subjected to cyclization condensation under reflux (about 90 to 110° C.) for 5 hours. Then, the polymer solution obtained in the above cyclization condensation was introduced to a bent-type screw biaxial extruder (Φ=29.75 mm, L/D=30) of a barrel temperature of 260° C., a rotation number of 100 rpm, a decompression degree of 13.3 to 400 hPa (10 to 300 mmHg), one rear bent, and four fore bents, at a processing speed of 2.0 kg/hour in terms of a resin amount. The polymer solution was subjected to cyclization condensation reaction and devolatilization in the extruder and extruded, to thereby obtain a transparent pellet (5). Table 2 shows the analysis resultants of the obtained pellet (5).

The obtained pellet (5) was melt-extruded from a T-die of a coat hanger type with a width of 150 mm using a biaxial extruder having a screw of 20 mmΦ to obtain a polarizer protective film (5) with a thickness of 80 μm.

The obtained polarizer protective film (5) was measured for the light transmittance at 380 nm in a thickness of 80 μm. Table 2 shows the results.

### Example 6

An experiment was conducted in the same way as in Example 5, except that 35 parts of methyl methacrylate (MMA), 10 parts of methyl 2-(hydroxymethyl)acrylate (MHMA), 2.5 parts of 2-[2′-hydroxy-5′-(methacryloyloxyethyl)phenyl]-2H-benzotriazole (RUVA-93 (Trade name) manufactured by Otsuka Chemical Co., Ltd.), and 2.5 parts of styrene (St) were charged, whereby a transparent pellet (6) was obtained. Table 2 shows the analysis results of the obtained pellet (6).

A polarizer protective film (6) with a thickness of 80 μm was obtained in the same way as in Example 5 from the obtained pellet (6). The light transmittance at 380 nm of the obtained polarizer protective film (6) in a thickness of 80 μm was measured. Table 2 shows the results.

### Example 7

The pellet (5) obtained in Example 5 and an acrylonitrile-styrene copolymer (AS resin) were kneaded in a weight ratio of 90/10 using a uniaxial extruder (Φ=30 mm), whereby a transparent pellet (7) was obtained. Table 2 shows the analysis results of the obtained pellet (7).

A polarizer protective film (7) with a thickness of 80 μm was obtained in the same way as in Example 5 from the obtained pellet (7). The light transmittance at 380 nm of the obtained polarizer protective film (7) in a thickness of 80 μm was measured. Table 2 shows the results.

### Example 8

To a reactor of 30 L equipped with a stirring device, a temperature sensor, a cooling tube, and a nitrogen introducing tube, 13.25 parts of methyl methacrylate (MMA), 6.25 parts of N-cyclohexylmaleimide (CHMI), 2.5 parts of 2-[2′-hydroxy-5′-(methacryloyloxyethyl)phenyl]-2H-benzotriazole (RUVA-93 (Trade name) manufactured by Otsuka Chemical Co., Ltd.), and 25 parts of toluene were charged. The mixture was raised in temperature to 100° C. while nitrogen was introduced thereto and refluxed. Then, 0.015 part of t-butylperoxyisopropyl carbonate (Kayacarbon BIC-75 (Trade name) manufactured by Kayaku Akzo Corporation) was added as an initiator.

Then, a mixture containing 15.75 parts of methylmethacrylate, 6.25 parts of N-cyclohexyl maleimide, 6 parts of styrene, 25 parts of toluene, and 0.081 part of t-butylperoxyisopropyl carbonate were bubbled previously with nitrogen gas, dropped to the reactor over 3.5 hours to perform solution polymerization under reflux (about 110° C.), and aged further over 3.5 hours.

The polymer solution was supplied to the biaxial extruder described in Example 1 with the barrel temperature controlled to 240° C., and devolatized under vacuum from the bents. The extruded strand was pelleted to obtain a transparent pellet (8). Table 2 shows the analysis results of the obtained pellet (8).

A polarizer protective film (8) with a thickness of 80 μm was obtained in the same way as in Example 5 from the obtained pellet (8). The light transmittance at 380 nm of the obtained polarizer protective film (8) in a thickness of 80 μm was measured. Table 2 shows the results.

### Comparative Example 2

In a 30-L reaction vessel equipped with a stirring device, a temperature sensor, a cooling pipe, and a nitrogen introduction pipe, 40 parts of methyl methacrylate (MMA), 10 parts of methyl 2-(hydroxymethyl)acrylate (MHMA), and 50 parts of toluene were placed, and the mixture was heated to 105° C. while nitrogen was being introduced thereto. After reflux, while 0.05 part of tert-amylperoxy isononanoate (Lupasol 570 (Trade name) manufactured by Arkema Yoshitomi Ltd.) was added as an initiator, and at the same time, 0.10 part of tert-amylperoxy isononanoate was dropped over 2 hours, the mixture was subjected to solution polymerization under reflux (about 105 to 110° C.), and further aged over 4 hours.

To the obtained polymer solution, 0.05 part of a stearyl phosphate/distearyl phosphate (Phoslex A-18 (Trade name) manufactured by Sakai Chemical Industry Co., Ltd.) was added, and a cyclization condensation reaction was conducted for 5 hours under reflux (about 90° C. to 110° C.). Then, to the polymer solution obtained by the cyclization condensation reaction, 2.5 parts of 2-(5-methyl-2-hydroxyphenyl)benzotriazole (TINUVIN P (Trade name) manufactured by Ciba Specialty Chemicals Inc.) were added. The mixture was stirred thoroughly and introduced into a bent-type screw biaxial extruder (Φ=29.75 mm, L/D=30) at a barrel temperature of 260° C., a rotation number of 100 rpm, a decompression degree of 13.3 to 400 hPa (10 to 300 mmHg), and with one rear bent and four front bents at a processing speed of 2.0 kg/hour in terms of a resin amount. A cyclization condensation reaction and devolatizing were performed in the extruder, and the polymer solution was extruded, whereby a transparent pellet (C2) was obtained. Table 2 shows the analysis results of the obtained pellet (C2).

A polarizer protective film (C2) with a thickness of 80 μm was obtained in the same way as in Example 5 from the obtained pellet (C2). The light transmittance at 380 nm of the obtained polarizer protective film (C2) in a thickness of 80 μm was measured. Table 2 shows the results.

### Examples 9 to 13

Transparent pellets (9) to (13) were obtained in the same way as in Example 5 except that the compositions of monomers to be polymerized were set to those shown in Table 1. Table 2 shows the analysis results of the obtained pellets (9) to (13).

Polarizer protective films (9) to (13) with a thickness of 80 μm were obtained in the same way as in Example 5 from the obtained pellets (9) to (13). The light transmittance at 380 nm of the obtained polarizer protective films (9) to (13) in a thickness of 80 μm was measured. Table 2 shows the results.

### Example 14

A transparent pellet (14) was obtained in the same way as in Example 5 except that 37.5 parts of MMA, 5 parts of MHMA, and 7.5 parts of RUVA-93 were used as monomers to be polymerized and 0.05 part of 2-ethylhexyl phosphate (Phoslex A-8 (Trade name) manufactured by Sakai Chemical Industry Co., Ltd.) as a catalyst of the cyclization condensation reaction. Table 2 shows the analysis results of the obtained pellet (14).

A polarizer protective film (14) with a thickness of 80 μm was obtained in the same way as in Example 5 from the obtained pellet (14). The light transmittance at 380 nm of the obtained polarizer protective film (14) in a thickness of 80 μm was measured. Table 2 shows the results.

### Example 15

A transparent pellet (15) was obtained in the same way as in Example 5 except that 35 parts of MMA, 5 parts of MHMA, and 10 parts of RUVA-93 were used as monomers to be polymerized and 0.05 part of 2-ethylhexyl phosphate (Phoslex A-8 (Trade name) manufactured by Sakai Chemical Industry Co., Ltd.) as a catalyst of the cyclization condensation reaction. Table 2 shows the analysis results of the obtained pellet (15).

A polarizer protective film (15) with a thickness of 80 μm was obtained in the same way as in Example 5 from the obtained pellet (15). The light transmittance at 380 nm of the obtained polarizer protective film (15) in a thickness of 80 μm was measured. Table shows the results.

TABLE 2

| | | | | | | Comparative | |
|---|---|---|---|---|---|---|---|
| | | Example 5 | Example 6 | Example 7 | Example 8 | Example 2 | Example 9 |
| Composition | MHA | 75 | 70 | 67.5 | 58 | 76 | 80 |
| | MHMA | 20 | 20 | 18 | — | 19 | 10 |
| | CHMI | — | — | — | 25 | — | — |
| | St | — | 5 | — | 12 | — | — |
| | AS resin | — | — | 10 | — | — | — |
| | RUV-A93 | 5 | 5 | 4.5 | 5 | — | 10 |
| | UVA-2 | — | — | — | — | — | — |
| | UVA-3 | — | — | — | — | — | — |
| | UVA-4 | — | — | — | — | — | — |
| | UVA-5 | — | — | — | — | — | — |
| | Tinuvin P | — | — | — | — | 5 | — |

| | | | | | | |
|---|---|---|---|---|---|---|
| Tg of resin (° C.) | 128 | 125 | 128 | 135 | 129 | 120 |
| Mw (×10⁴) | 14.2 | 13.5 | 13.8 | 18.5 | 14.1 | 14.6 |
| YI of resin | 1.3 | 1.2 | 1.7 | 1.8 | 2.2 | 1.0 |
| Resistance to | ∘ | ∘ | ∘ | ∘ | Δ | ∘ |
| thermal | | | | | | |
| decomposition of | | | | | | |
| resin | | | | | | |
| Light | 8.8 | 9.3 | 9.2 | 13.2 | 5.4 | 4.8 |
| transmittance at | | | | | | |
| 380 nm (%) | | | | | | |
| (thickness: 80 μm) | | | | | | |

| | | Example | Example | Example | Example | Example | Example |
|---|---|---|---|---|---|---|---|
| | | 10 | 11 | 12 | 13 | 14 | 15 |
| Composition | MHA | 72 | 72 | 72 | 75 | 75 | 70 |
| | MHMA | 20 | 20 | 20 | 20 | 10 | 10 |
| | CHMI | — | — | — | — | — | — |
| | St | — | — | — | — | — | — |
| | AS resin | — | — | — | — | — | — |
| | RUV-A93 | — | — | — | — | 15 | 20 |
| | UVA-2 | 8 | — | — | — | — | — |
| | UVA-3 | — | 8 | — | — | — | — |
| | UVA-4 | — | — | 8 | — | — | — |
| | UVA-5 | — | — | — | 5 | — | — |
| | Tinuvin P | — | — | — | — | — | — |

| | | | | | | |
|---|---|---|---|---|---|---|
| Tg of resin (° C.) | 129 | 129 | 130 | 128 | 121 | 121 |
| Mw (×10⁴) | 14.4 | 14.3 | 14.5 | 14.5 | 13.9 | 14.5 |
| YI of resin | 1.9 | 2.0 | 2.2 | 1.0 | 1.5 | 2.0 |
| Resistance to | ∘ | ∘ | ∘ | ∘ | ∘ | Δ |
| thermal | | | | | | |
| decomposition of | | | | | | |
| resin | | | | | | |
| Light | 5 | 5.2 | 5 | 4.8 | 3.7 | 2.7 |
| transmittance at | | | | | | |
| 380 nm (%) | | | | | | |
| (thickness: 80 μm) | | | | | | |

### INDUSTRIAL APPLICABILITY

The polarizer protective film and the polarizing plate of the present invention can be preferably used for various kinds of image display apparatuses (liquid crystal display apparatus, organic EL display apparatus, PDP, etc.).

1. A polarizer protective film, which has a light transmittance of 30% or less at 380 nm in a thickness of 80 μm, and is obtained by molding a forming material containing a resin component, which contains as a main component a (meth)acrylic resin obtained by polymerizing a monomer composition containing a UV-absorbing monomer and a (meth)acrylic monomer, by extrusion molding.

2. A polarizer protective film according to claim 1, wherein the UV-absorbing monomer comprises a benzophenone-based UV-absorbing monomer and/or a benzotriazole-based UV-absorbing monomer.

3. A polarizer protective film according to claim 1 or 2, wherein a content of the UV-absorbing monomer in the monomer composition is 1 to 30% by weight.

4. A polarizer protective film according to claim 1 or 2, wherein the (meth)acrylic resin has a (meth)acrylic resin having a lactone ring structure.

5. A polarizer protective film according to claim 1 or 2, which has a b-value of less than 1.5 in the thickness of 80 μm.

6. A polarizer protective film according to claim 1 or 2, wherein the forming material contains, with respect to 100 parts by weight of the resin component, 0.2 part by weight or more of an antioxidant having a weight reduction of 10% or less in heating at 280° C. for 20 minutes.

7. A polarizer protective film according to claim 6, wherein the antioxidant contains a phenol-based antioxidant.

8. A polarizer protective film according to claim 7, wherein the antioxidant contains, with respect to 100 parts by weight of the resin component, 0.1 part by weight or more of the phenol-based antioxidant and 0.1 part by weight or more of a thioether-based antioxidant.

9. A polarizer protective film according to claim 7, wherein the antioxidant contains, with respect to 100 parts by weight of the resin component, 0.1 part by weight or more of the phenol-based antioxidant and 0.1 part by weight or more of a phosphorus-based antioxidant.

10. A polarizer protective film according to claim 1 or 2, wherein a temperature of the forming material during the extrusion molding is 250° C. or higher.

11. A polarizing plate, comprising:
a polarizer formed of a polyvinyl alcohol-based resin; and
the polarizer protective film according to claim 1 or 2,
wherein the polarizer is bonded to the polarizer protective film via an adhesive layer.

12. A polarizing plate according to claim 11, wherein the adhesive layer is formed of a polyvinyl alcohol-based adhesive.

13. A polarizing plate according to claim 11, further comprising a pressure-sensitive adhesive layer as at least one of outermost layers.

14. An image display apparatus, comprising at least one of the polarizing plates according to claim 11.
